(19) United States
(12) Patent Application Publication
(10) Pub. No.: US 2006/0282248 A1
(43) Pub. Date: Dec. 14, 2006

(54) Integrated simulation system

(76) Inventors: Keiji Kageyama, Ami (JP); Ichiro Nishigaki, Ishioka (JP); Yasuo Sasaki, Tokyo (JP); Mitsuo Matsunaga, Yokohama (JP); Makoto Onodera, Tsuchiura (JP); Ichiro Kataoka, Hitachinaka (JP); Hiromitsu Tokisue, Kasumigaura (JP)

Correspondence Address: MCDERMOTT WILL & EMERY LLP, 600 13TH STREET, N.W., WASHINGTON, DC, 20005-3096, US

(21) Appl. No.: 11/212,119

(22) Filed: Aug. 26, 2005

(30) Foreign Application Priority Data
Jun. 14, 2005 (JP) 2005-174032

(51) Int. Cl. G06F 17/50

(52) U.S. Cl. 703/13

(57) ABSTRACT

An integrated simulation system, for integrally simulating a simulation target having a plural number of elements therein, comprises: simulators, each being provided, independently, for each of the elements, for simulating those elements, respectively; and a corporation means having a common data area for connecting the plural number of simulators accessible thereto. The corporation means has a time management means for managing simulation time, when a synchronization request is issued from anyone of those simulators.

### BACKGROUND OF THE INVENTION

The present invention relates to an integrated simulation system, and in particular, it relates to a simulation system being suitable for assisting design and development of a product, including embedded software therein, for example.

In the deign and development of a mechanical system, as an assembly of mechanical parts, which are driven and controlled through an electrical system, such as, electric/electronic circuits, for example, with an aid of embedded software installed therein, the mechanical system and the electrical system are designed, independently, with using the respective tools for exclusive use thereof.

However, since the product operates in combination with the software, the electrical system and the mechanical system, in one body, or as a unit thereof, therefore it does not operate normally, if even one of them does not operate normally. Confirmation and/or verification must be done upon the operation under the condition of combining the software, the electrical system and the mechanical system.

In general, in case when making debug and/or verification upon the software of the product, which includes an embedded application therein, samples of the electrical system and the mechanical system are combined with the software. However, if starting the debug and verification of the software after completion of those samples of the electrical system and the mechanical system, a term for developing the product extends too long, and there must be prepared the samples in a large number thereof.

Then, there is caused a necessity of simulation of the electrical system and the mechanical system; i.e., an electrical-system simulator and a mechanical-system simulator are operated with an aid of a software simulator, thereby conducting those debug and verification thereupon. As a method for combining or integrating the simulations of the electrical system and the mechanical system, in more details, there are two (2) methods.

First one is a method of combining the respective simulators of the electrical system and the mechanical system, so as to make the simulation. Thus, a software simulator provides an output an operation instruction data for operating the mechanical system, while an electrical-system simulator converts the operation instruction data into an input for an actuator of the mechanical system; whereby the mechanical-system simulator calculates out an actuator output depending on the input for the actuator, thereby conducting the simulation. Or, that is a method of converting the operation of the mechanical system into a sensor output through a simulator for a sensor, so as to turns that sensor output back to the software simulator through the electrical-system simulator, while the software simulator repeats the steps, such as, outputting next instruction data to the mechanical system according to the sensor output, and conducting necessary data processes, for example.

A second one is a method of conducting the simulation while letting the software simulator, the electrical-system simulator and the mechanical-system simulator to operate, independently, thereby obtaining the simulation thereof. Thus, each of the simulators makes only a simulation, about on which input it should operates and which output it should provide, within itself. For example, the mechanical simulator operates upon only an actuator input(s), but it does not grasp on which kind of operation instruction data is outputted by the software simulator. The electrical-system simulator is also similar to that. Also, in case where a sensor simulator is provided for detecting operations of the mechanical system, the sensor simulator responds, but only to the operation of the mechanical system. With such the second method, since the electrical system simulator and the mechanical-system simulator can make an operation fitting to an actual physical phenomenon, therefore it can be expected to achieve the more accurate simulation thereof.

However, with any one of such the methods mentioned above, there are many cases where there is the difference in the simulation time thereof, among the software simulator, the electrical-system simulator and the mechanical-system simulator. For example, the software simulator can made the simulation within an order of nanoseconds, but the mechanical-system simulator make it within an order of millisecond; therefore, there is a necessity of dealing with such the difference in the simulation time. In particular, when trying to increase the accuracy of simulation, the response of the mechanical-system simulator takes the time, sometimes, as several hundreds (100) times long as an actual time thereof.

Then, conventionally, in case when linking the software simulator, the electrical-system simulator and the mechanical-system simulator, as a unit, for example, there is proposed a mechanism of thinning or cutting out a portion taking times for calculation, thereby absorbing the speed difference when executing the software simulator and the mechanical-system simulator, in Japanese Patent Laying-Open No. 2003-30251 (2003), for example. However, in this publication, there is only described a method of transmitting data through a common memory, as an example for building up an integration simulator of the software simulator, the electrical-system simulator and the mechanical-system simulator, in actual.

Also, as a method for linking those two (2), i.e., the software simulator and the electrical-system simulator, there is a simulation method of operating in synchronism, for example, in Japanese Patent Laying-Open No. 2003-22296 (2003).

However, in the case where the objects of the simulations are plural in the constituent elements thereof, such as, the software, the electrical system and the mechanical system, etc., for example, and in particular, if trying to make the simulation on them by means of only one (1) of the simulator, then the simulator comes to be large in the scale, and there are sometimes resulted the cases where correct estimations cannot be obtained on the relationship of the mutual responses among those constituent elements.

Then, taking the fact that, in general, an each simulator for the plural numbers of constituent elements was already developed into the consideration, it is preferable to build up an integrated simulation by letting them to operate in cooperation with, while each the simulator to operate independently. With this method, it is possible to verify on whether the software is so constructed or not, that it can deal with it, correctly, even if the mechanical-system simulator and/or the electrical-system simulator make(s) an operation beyond an estimation thereof. Also, with provision of a sensor simulator for detecting the operation of the mechanical system by means of a sensor, so as to turn it back to the software, it is possible to obtain a simulation being accurate much more.

However, when the software needs the feedback of operation condition(s) of the mechanical system and/or the electrical system, so as to determine the process contents of itself, it is necessary to bring each of the simulators operating independently, to be in synchronism with each other. For example, when outputting a next operation instruction after confirming a response of the mechanical system to the operation instruction which the software outputs to the mechanical system, it is necessary to obtain that response of the mechanical system within a predetermined time period. In general, the software includes a process therein, for moving the process into an error processing, when the mechanical system and/or the electrical system fails to make an operation estimated within a certain time period, since it assumes that an error is generated within an object, and therefore, if failing to obtain synchronization on simulation for each among those simulators, it is impossible to make an estimation, correctly, about a relationship in mutual responses, for each of the constituent elements.

Such the problem should not be limited only to the integrated simulation, which includes the software, the electrical system and the mechanical system, as the constituent elements thereof. For example, within an oscillation or vibration simulation of the structure dealing with a liquid, if a target of the simulation is constructed with plural numbers of elements, it is necessary to build up an integrated simulation by brining plural numbers of the simulators for simulating plural numbers of the elements to operate in cooperation with each other.

### BRIEF SUMMARY OF THE INVENTION

An object according to the present invention is to provide an integrated simulation system, including plural numbers of simulators therein, being operated in cooperation with each other, and in particular, to achieve synchronization for each of the simulators while maintaining an execution efficiency and functions thereof.

For accomplishing the object mentioned above, according to the present invention, there is provided an integrated simulation system, for integrally simulating a simulation target having a plural number of elements therein, comprising: simulators, each being provided, independently, for each of said elements, for simulating said elements, respectively; and a corporation means having a common data area for connecting said plural number of simulators accessible thereto, wherein said corporation means has a time management means for managing simulation time, when a synchronization request is issued from one of said simulators, between the simulator requested to be in synchronism.

Thus, with the structure of making a management on the simulation times between the simulators relating to each other, only when a synchronization request is made from the each simulator, it is possible to bring the respective simulators into the synchronism with, as well as, maintaining the execution efficiency and the function of the each simulator.

In addition to the structure mentioned above, the integration simulation system, according to the present invention, may be constructed, in combination with the following means, appropriately:

(1) The plural numbers of simulators may be constructed, being able to transmit data, mutually, through the common data area. In such case, data transmission between two (2) simulators (for example, between the software simulator and the mechanical-system simulator) may be achieved, while relaying through other simulator (for example, the electrical-system simulator).

(2) Each of the simulators takes synchronization on the simulation time, with using the time management means, when a simulation process of itself is a process relating a simulation of other simulator. In this case, the common data are a may be provided with an area for storing synchronization time information therein, which can be shared in common with the simulator issuing the synchronization request and the simulator requested to be in synchronism therewith, and an area for storing synchronization completion information therein, which is generated when the simulator requested to be in synchronism therewith reaches to a synchronization time, whereby the simulator requesting synchronization obtains operation data of the simulator requested to be in synchronization within the common data area, after confirming the synchronization completion information through accessing to the common data area.

(3) The integrated simulation system may further comprises a user interface having a display means for displaying simulation conditions of the plural number of simulators, wherein the user interface has a display mode selecting means for displaying the simulation conditions of the respective simulators, alone or in a group thereof. Thus, it is so constructed that a user can confirm the respective simulation conditions, appropriately, i.e., the software simulator, the electrical-system simulator and the mechanical-system simulator. With this, in case when a problem occurs in operations of the electrical system and the mechanical system, for the user, it is possible to study the reasons, etc., of that problem, easily.

(4) It is possible to obtain an interruption to the software by means of the simulation. Namely, within the integrated simulation system as was mentioned above, there may be further provided an interruption processing means for simulating an interruption with using a signal mechanism of an operating system, when an interruption request is made from the plural number of simulators. With this, it is possible to make the simulation on the interruption, in the same operation to that of actual software. Thus, when the simulation steps are built up in a loop-like manner, it is possible to install a process for checking a presence of the interruption, within that loop; however, when such process is installed into the software simulator, for checking the presence of the interruption, periodically, it is possible to prevent the software from differing in the operation thereof from an actual operation of the software.

(5) Within the integrated simulation system as was mentioned above, there may be further provided a data operation interface, being connected accessible to the cooperation means, wherein the data operation interface can change the data within the common data area, when any one of the plural numbers of simulators executes simulation. With this, it is possible to make up the condition, which can be hardly reproduced or set up in an actual machine, or an abnormal condition.

(6) Within the integrated simulation system as was mentioned above, there may be applied a software simulator for simulating software embedded into equipment, a mechanical-system simulator for simulating a mechanical apparatus, which is driven and controlled by said software, and an electrical-system simulator for simulating an electrical system, which converts data transmitted between said software simulator and said mechanical-system simulator. In such the case, since the target being actually controlled and operated by the software is the hardware, which is built up with the actual electricalal system and the actual mechanical system, it is desired to improve accuracy of a simulation model, comparing between the simulation results, with using simulation models of the electrical system and the mechanical system, and debug and result of verification obtained with using an actual machine therein. For dealing with this, the integrated simulation system as described in the above may have the structure, wherein each of the mechanical-system simulator and the electrical-system simulator has a switching means, for switching over if it individually accesses an actual machine to the common data area, respectively, or if it accesses the simulator of itself in combination with the actual machine.

(7) It is preferable to apply a physical model simulator for the mechanical-system simulator having high accuracy. However, there are cases where a mechanical-system simulator having a quick response speed is required, even at the cost of accuracy a little bit. In such the case, the mechanical-system simulator comprises a hypothetic model simulator therein. And, this hypothetic model simulator may have such the structure that a response data, which is simulated in advance, responding to an operation instruction of the software simulator, so as to obtain an operation result responding to the operation instruction of the software simulator, upon the response data, thereby to be stored within the common data area. This improves the response speed of the mechanical-system simulator, and therefore it improves the execution efficiency of the integrated simulation. Also, the mechanical-system simulator may be constructed to comprise the physical model simulator and the hypothetic model simulator, therein, so that both can be switched over depending upon the simulation accuracy.

(8) In the integrated simulation system as described in the above, with provision of a means for extracting an access port (i.e., a physical port) for accessing to the electrical-system simulator and the mechanical-system simulator, upon basis of source program of the software, and for automatically producing a variable switching definition file for use of referring to the common data area, defining an access address on said common data area corresponding to the access port, within the software simulator, it is possible to produce a source program therein, for use of the software simulator.

Thus, when transmitting the data through the common memory area, since the source program of the software is so described that the data is inputted/outputted to the physical port of the actual electrical system or the like, the software simulator must be constructed while chaining an address for input/output of data to the address on the common memory area. Normally, since such work of changing a reference address of the source program is made manually, with using a program and an editor by a human being, therefore, it comes to be a large-scaled jobs depending on the scale of the program; however, according to the present invention, the production work of the source program for use in the software simulator can be made, easily.

(9) The integrated simulation system, as described in the above, may further comprises, therein: a database for reserving and managing the simulation models, constituent elements of the simulation models, the simulation conditions, and the simulation results of the software simulator, the mechanical-system simulator and the electrical-system simulator. With this, in case when executing the plural numbers of simulations, while changing the simulation model and the simulation condition, but management can be made easily, upon those simulation models and the results thereof. Thus, when executing the simulations in plural numbers thereof, after that execution of the simulations, the contents thereof come to be unclear accompanying with the passage of times; i.e., the management thereof is difficult, but according to the present invention, an improvement can be obtain on it.

(10) In case of comprising the database within the integrated simulation system as described in the above, it is preferable to further comprises a user interface for enabling to search, refer and edit the information of the database, in relation to execution of the simulation. And, it may also so constructed that the user interface compares the simulation model and the simulation condition to contents of those reserved within the database, when the simulation is executed, so as to provide a simulation model and a result thereof, which are same or analogous thereto, before execution of the simulation.

(11) Within the integrated simulation system as described in the above, the cooperation means may have a switching means for switching over if it individually accesses an actual machine to the common data area, respectively, or if it accesses the simulator of itself in combination with the actual machine, and also the user interface may make management on the object, the processing time and the simulation accuracy of the simulation, in combination with those simulations, including the actual machine therein, and simulation result thereof, thereby being able to provide a simulation modeling depending on the object, the processing time and the accuracy thereof; i.e., enabling to have a function of increasing the accuracy of simulation modeling. Further, the user interface may display data corresponding thereto, about plural numbers of simulation results, in same expression thereof, on the display apparatus.

(12) The integrated simulation system, as described in the above, may further comprises: an output means for outputting the simulation models, the simulation conditions, and the simulation results, which are stored within the database, through data in a format corresponding to an arbitrary display apparatus.

Thus, according to the present invention, within the integrated simulation system cooperating plural numbers of the simulators therein, it is possible to bring those simulators into the synchronism with, respectively, while maintaining the execution efficiency and the function thereof.

### BRIEF DESCRIPTION OF THE SEVERAL VIEWS OF THE DRAWING

Those and other objects, features and advantages of the present invention will become more readily apparent from the following detailed description when taken in conjunction with the accompanying drawings wherein:

FIG. 1 is a block diagram of an integrated simulation system, according to an embodiment of the present invention;

FIG. 2 is a view for showing the details of the integrated simulation system shown in FIG. 1 mentioned above;

FIG. 3 is a flowchart for showing the operations of the electrical system, mechanical system and software system simulators;

FIG. 4 is a view for showing an example of data structure;

FIG. 5 is a flowchart for showing operation of a synchronization process module;

FIG. 6 is a view for explaining about an interruption simulation;

FIG. 7 is a view for showing an example of data for the interruption simulation;

FIG. 8 is a view for explaining about the simulation within the integrated simulation system;

FIGS. 9 and 10 show an example of display screens within the integrated simulation system;

FIGS. 11 through 13 are views for explaining about an automatic production method of a switch definition file;

FIG. 14 is a view for explaining about a production method of a hypothetic model;

FIG. 15 is a view for explaining about switching over between a physical model simulator and a hypothetical model simulator;

FIG. 16 is a view for showing an example of a simulation database;

FIG. 17 is a view in relation with a user interface, and in particular, an example of the display screen;

FIG. 18 is also a view in relation with a user interface, and in particular, an example of a file menu;

FIG. 19 is also a view in relation with a user interface, and in particular, an example of a setup menu; and

FIG. 20 is a block diagram for showing an integrated simulation system, according to another embodiment of the present invention.

### DETAILED DESCRIPTION OF THE INVENTION

Hereinafter, embodiments according to the present invention will be fully explained by referring to the attached drawings.

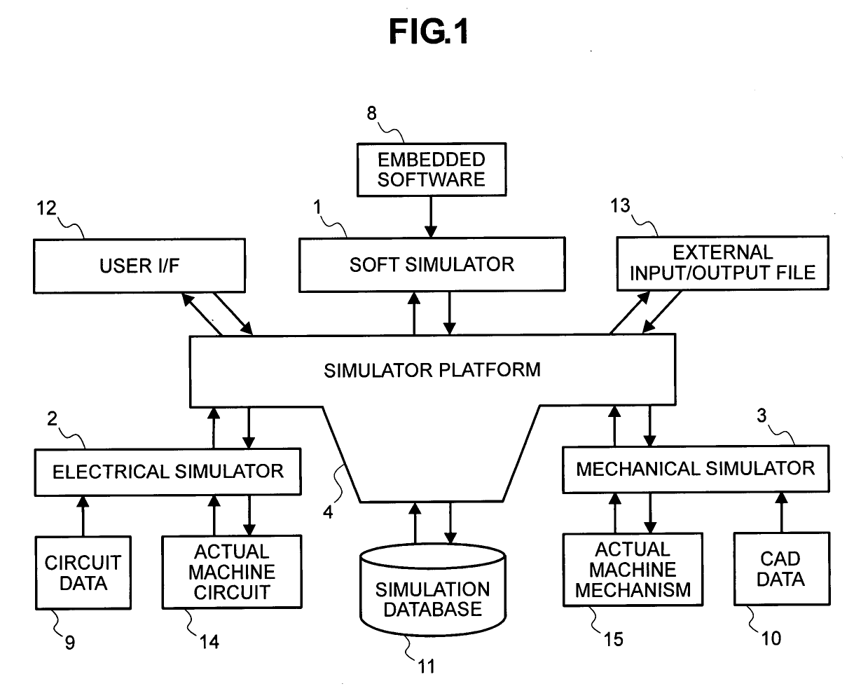

FIG. 1 shows the basic structures of an integrated simulation system, according to an embodiment of the present invention. The present embodiment, as shown in FIG. 1, relates to a system for executing simulation upon a product, having mechanical parts to be driven and controlled through an electrical system, such as, electric/electronic circuits, etc., with an aid of embedded software installed therein, in corporation with a software simulator 1, an electrical-system simulator 2 and a mechanical-system simulator 3, each being independent from one another. The software simulator 1, the electrical-system simulator (or, a mechanical simulator) 3 are connected with a simulator platform (hereinafter, being called only by a “platform”) 4.

The platform 4 makes up a corporation means for unifying or integrating the respective simulators; i.e., the software simulator 1, the electrical-system simulator 2 and the mechanical-system simulator 3. Thus, in the present embodiment, the platform 4 has a common memory area, which builds up a common data area for enabling data transmission, at least between the software simulator land the electrical-system simulator 2, between the electrical-system simulator 2 and the mechanical-system simulator 3. However, it is also possible to transmit data between the software simulator 1 and the mechanical-system simulator 3, directly. Also, data may be transmitted between the respective simulators, directly. Or each simulator may have a data display means for an exclusive use thereof.

The platform 4 converts mechanical system driving data, which is outputted from the software simulator 1 in the form of digital data, into data corresponding to an analog amount thereof, thereby to be transferred to the electrical-system simulator 2. The platform 4 converts the data, i.e., a control signal for driving an actuator, such as, a motor, etc., which is outputted from the electrical-system simulator 2, and/or a parameter for controlling a rotation speed, etc., into data, such as, a motor driving current and/or a pulse number, etc., to be transferred to the mechanical-system simulator 3. It also has a function of converting the operation data of the mechanical-system simulator 3 into a sensor output of position detector, etc., thereby to turn that data back to the electrical-system simulator 2, and further a processing function of generating an interruption to the software simulator 1, while converting the data of an analog image outputted from the electrical-system simulator 2 into the digital data thereof.

The common data area, which is provided within the platform 4, should not be limited only to the common memory area, which was adopted in the present embodiment, and it may be a means being accessible, equally, from each of the simulators 1-3, each operating independently. For example, the following may be applied therein:

(a) One or more of data files, which is/are to be prepared above a file system, and an interface means for accessing to the file(s);

(b) A common memory area, which can be assigned on the memory, or a data area, which has a function being equal to that, and an interface means for accessing to the area(s); and

(c) A system in the form of client and server, which is built up with a server process for managing only the data of the platform 4, together with those while assuming that each of the simulators is a client process, etc. where, in the case of (c), the interface means is embedded into the server system.

The software simulator 1 takes in the embedded software 8, so as to conduct a simulation thereon. The electrical-system simulator 2 takes into circuit data 9, so as to conduct a simulation on that circuit. The mechanical-system simulator 3 takes into CAD data for the design of the mechanical system, so as to execute a simulation thereon.

The platform 4 may includes a user interface 12 therein. The user interface 12 may includes, at least, a viewer for graphically displaying a situation of the simulation, and a data operation interface for a user to operate the data when executing the simulation and/or the parameter(s) for the simulation, etc. From the platform 4, the user interface 12 may be constructed to be separate, as shown in FIG. 1.

Within the platform 4, there may be included a time management module for managing simulation times for the respective simulators 1 to 3, a means for switching over between the electrical-system simulator 2 and a circuit 14 of an actual machine, a means for switching over the mechanical-system simulator 3 and a mechanical system 15 of the actual machine, respectively. Those switching means may be included within an inside of the respective simulators 2 and 3. In the present embodiment, the switching means between the actual machine and the simulator is included within an inside of the simulator, respectively. To the platform 4 is connected a simulation database 11. The simulation database 11 makes holding/management of data in relation to the simulations.

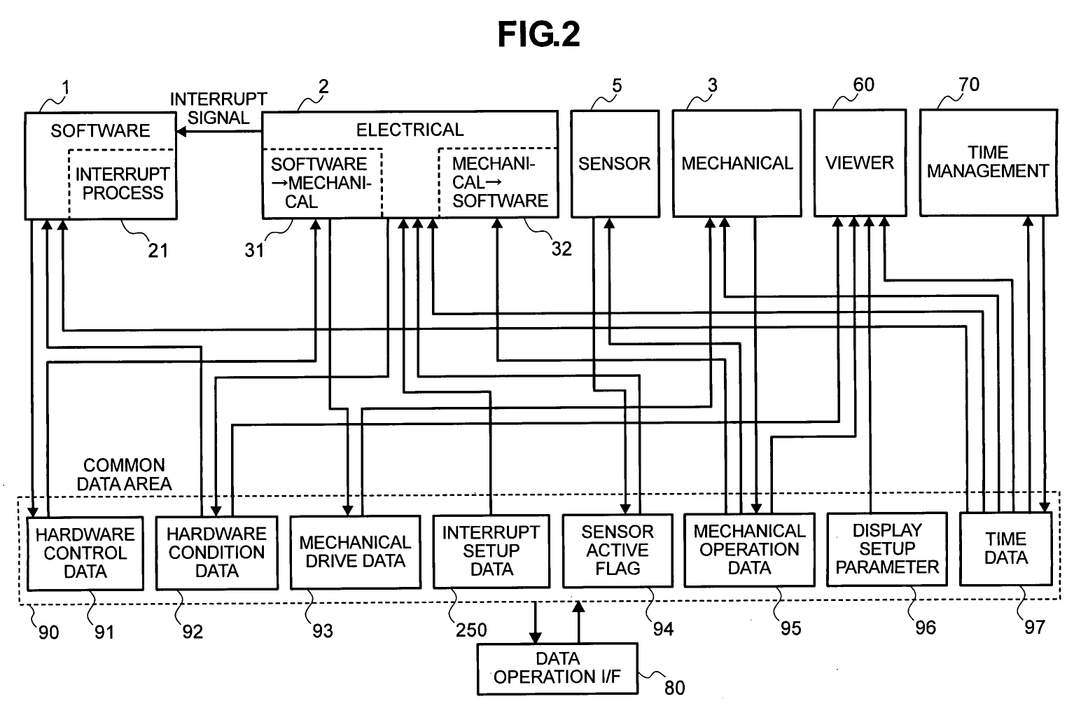

FIG. 2 shows a view for showing details of the structures shown in FIG. 1 mentioned above, surrounding the platform 4. Within the platform 4, there is provided a common data area 90, through which the each module transmits the data, as is shown by an enclosure of dotted lines. Within the common data area 90 are included a hardware control data 91, a hardware condition data 92, a mechanical-system drive data 93, a sensor active flag 94, a mechanical-system operation data 95, a display setup parameter 96, and a time data 97, etc.

With the common data area 90 are connected, in addition to the software simulator 1, the electrical-system simulator 2 and the mechanical-system simulator 3, a sensor simulator 5 in an accessible manner. Herein, the sensor simulator 5 is a module for simulating a sensor to grasp the condition of the mechanical-system simulator 3, electrically, and in the present embodiment, it is independent from the mechanical-system simulator 3 or the electrical-system simulator 2. Within the software simulator 1 is provided an interruption processor portion 21, as a sub-module thereof. Within the electrical-system simulator 2 are included a transmitter portion 31, which transmits an operation instruction for the mechanical system from the software simulator 1 to the mechanical-system simulator 3, and a transmission portion 32, which transmits the data from the mechanical-system simulator 3 to the software simulator 1, on the contrary thereto.

To the common data area 90 are connected a viewer 60 for displaying a condition of the simulation thereon, a time management module 70 for managing the time of simulations, and a data operation interface (I/F) 80 for a user to check or alter the data when simulating, in an accessible manner.

Hereinafter, explanation will be given about basic operations of the integrated simulation system, comprising such the common data area 90, which is constructed in such a manner as was mentioned above. The software simulator 1 writes an operation indicating data, to be applied to the mechanical-system simulator 3, into the hardware control data 91. The electrical-system simulator 2 reads out that data, and writes the data of voltage and current, to be applied actually into the mechanical-system simulator 3, into the mechanical-system drive data 93. The mechanical-system simulator 3 makes simulation upon an operation in accordance with the data, which is written into the mechanical-system drive data 93, and it writes data of a result of that operation into the mechanical-system operation data 95. The sensor simulator 5 reads out the operation data of the mechanical system within the mechanical-system operation data 95, and writes active information into the sensor active flag 94 when becoming active. The electrical-system simulator 2 reads out the mechanical-system operation data 95 and the sensor active flag 94, and writes them into the hardware condition data 92. The software simulator 1 reads out the hardware condition data 92, and thereby executes the processes, such as, about which kind of process should be made responding to that condition, or which kind of operation instruction should be given to the mechanical-system simulator 3, next, for example.

Herein, the software simulator 1, the electrical-system simulator 2, the mechanical-system simulator 3 and the sensor simulator 5 execute the operation simulation, but upon only the data, which they wrote therein by themselves, respectively. Accordingly, it is not grasped on which condition the simulators are, or on which process the simulators are going to make, about the other elements. With the structures in such manner, the operation of the mechanical-system simulator 3 can be determined only by the data of actuator, which is given from the electrical-system simulator 2, and thereby enabling to divide it from the conditions of the software simulator 1 and the sensor simulator 5, completely. Also, the sensor simulator 5 determines on whether it comes to be active or not through checking on only the condition of the mechanical-system simulator 3. For this reason, it can make the simulation, accurately, as a sensor, independent from the conditions of the software simulator 1 and the electrical-system simulator 2.

On the other hand, the viewer 60 is installed within the user interface 12, and it reads in the hardware condition data 92 and the mechanical-system operation data 95, thereby displaying the operation condition of the mechanical system on the graphic screen. The mechanical-system operation data 95 contains only that of the movement of the mechanical system (i.e., position data). The hardware condition data 92 are other than those of the mechanical-system operation data 95, for example, an indicator mounted on an electric circuit and an display device, etc. With an aid of the hardware condition data 92 and the mechanical-system operation data 95, an actual image is displayed, for a user to seen it.

The data operation I/F 80 is an user interface for displaying and re-writing the data with in the common data area 90. When making the simulation, there are sometimes cases where checking is made on whether the software and/or hardware can deal with an abnormal condition, appropriately, or not. For dealing with such the case, the data is re-written in the data operation I/F 80, so as to produce the abnormal condition. With an aid of the viewer 60 and the data operation I/F 80, it is possible to grasp the condition of executing the simulations, graphically, and also the details thereof through the numerical value thereof. It is also possible to make a check on the abnormal condition caused due to re-writing of data.

As was mentioned above, since the data is transmitted among the respective simulators through the common data area 90, which is provided within the platform 4, therefore, according to the present embodiment, it is sufficient to describe a data access portion for each of the simulators only into the platform 4; thereby obtaining the simulators, which can be defined, easily. As a result thereof, it is possible to add the functions, easily, which are necessary for the integrated simulation, for example, the data operation I/F 80 enabling to change the data within the platform 4 any time, the time management module 70 for managing the time of simulations, and the viewer 60 for displaying the condition of simulation thereon, etc.

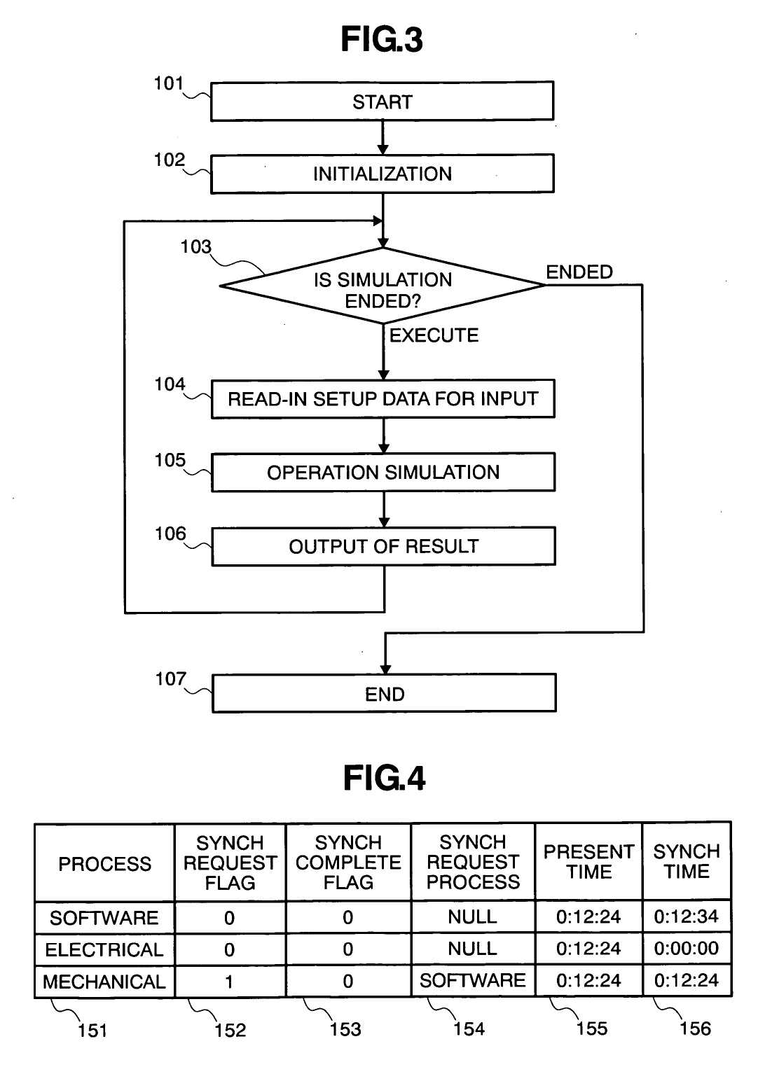

FIG. 3 shows a flowchart of basic operations within an inside of the software simulator 1, the electrical-system simulator 2, the mechanical-system simulator 3 and the sensor simulator 5. When being started (101), each of the simulators executes an initialization, such as, clearing of work variables, setting of default values, etc., for example (102). Next, it determines on whether the simulation should be ended or not (103). In this determination, checking is made on the data corresponding to a main switch of the mechanical system, for example, and if determining that it is in an OFF condition, then consideration is made that the mechanical system is stopped; therefore, the simulation is ended (107). As the data to be used in this determination may be the data, corresponding to an electric power to be supplied to the mechanical system and/or the electric circuits, or the data, which is separately defined for use in execution of the simulation. In case where it is determined to execute in the determination for end of simulation 103, the data to be inputted is read in (104), to execute the simulation on the operation upon basis of that data (105), and a result obtained is outputted (106). As was mentioned previously, those data are inputted/outputted to/from the common data area 90. With such the structures and also the basis or fundamental operation of the respective simulators, an integrated simulation can be made unifying the software simulator, the electrical-system simulator and the mechanical-system simulator, in the form of conformity with the physical phenomenon.

<Time Management Module 70>

Herein, explanation will be given about the synchronization processing of the respective simulators, which the time management module 70 executes thereupon. Each of the simulators cannot process it, correctly, since it operates independently, in particular, in case when the process relating to the time, such as, a waiting process for a response of the mechanical system, etc., is installed into the embedded software 8. By the way, the time waiting process itself can be achieved when executing the simulation, if using a system call or the like, for calling up an internal time of the computer. However, the most important thing for obtaining the integrated simulation lies, if the mechanical system operates a predetermined operation within a time limit or not, but not in that the software has the time limit in a sense of the actual time. Then, there is sometimes a necessity of brining the time for simulation on the operation by the mechanical-system simulator 3 and the time for simulation by the software simulator 1 into synchronism.

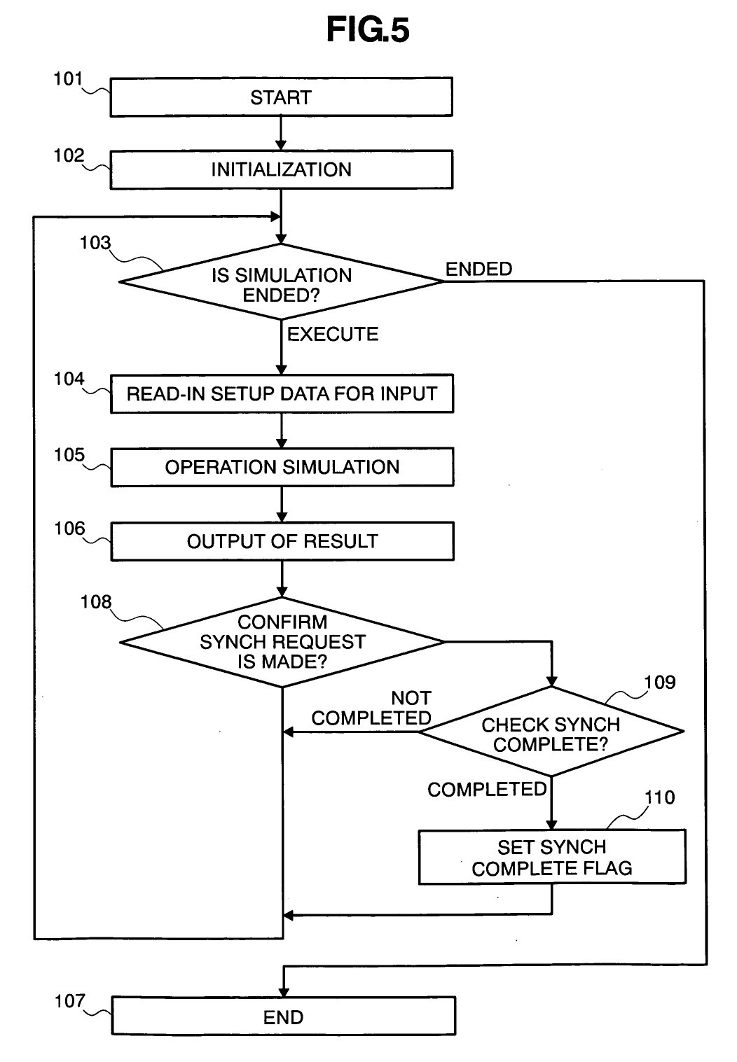

The time management module 70 achieves the synchronization processing, as will be explained by using FIGS. 4 and 5, by extending the basic operation processing of the respective simulators, while maintaining the simulations in conformity with the physical phenomenon. FIG. 4 shows an example of structure of the data, which is prepared within the common data area 90 for the synchronization processing, and in the example of this figure is shown a case where the software simulator 1 requests the synchronization to the mechanical-system simulator 3. The software simulator 1 informs a synchronization request to the mechanical simulator 3, being a partner of synchronization, at a time-point when it is needed. This synchronization request is executed by setting up a synchronization-request flag in a data area, which the mechanical-system simulator 3 refers to. At the same time of this, for indicating that the requester of the synchronization request is itself, it writes an identification (ID) code of the software simulator 1 into a synchronization request process 154. This ID code may be any kind of code, as far as each of the simulators can be identified in the form thereof; for example, there may be utilized a process number which an operating system of the integration simulator manages therein.

Also, a time-point where the synchronism should be taken is set at a synchronization time 156. The mechanical-system simulator 3 executes the simulation of itself, and it writes the present time at the present time 155, every time when finishing an execution loop, and makes comparison with the synchronization time 156, as well. Then, at the time when the present time of the mechanical-system simulator 3 itself reaches to the synchronization time 156, it set up a synchronization completion flag 153. The software simulator 1 obtains the operation data of the mechanical-system simulator 3, the data of the sensor simulator 5, etc., at the time-point when confirming that the synchronization completion flag 153 is set up, and the mechanical-system simulator 3 conducts a determining process on whether a desired operation is performed or not within the time limit.

FIG. 5 shows a flowchart of steps of the synchronization process mentioned above. After completing the operation simulation 105 shown in FIG. 3, the synchronization process is performed, every time when completing the execution loop outputting a result thereof (106). Confirmation is made on whether a synchronization request is made or not from other simulators (108). When there is the synchronization request, comparison is made between a simulator time of the transmitter (i.e., a sensor) of that synchronization request and a simulator time of the simulator itself, so as to make checking on whether they are in synchronism or not (109). When determining that synchronization is obtained in that check, the synchronization completion flag 153 is set up (110), and the process turns back to an original loop. But, when determining that synchronization is not yet obtained, it means that the simulator itself is retarded with respect to the simulator requesting the synchronization, and therefore, for the purpose of continuing the simulation on operation further, the process turns back to the original loop as it is. No synchronization request is made in the confirmation on presence of the synchronization request 108; then the process continues the simulation, as it is.

As was mentioned above, each the simulator makes up the synchronization on the simulation time, through the time management module 70, when performing such a process that the simulation process of itself comes to be related with the simulation time of the other simulator. Thus, the common data area 90 has an area for storing therein the other simulator of being synchronization target and synchronization time information, which a one simulator requests, and other area for storing therein synchronization completion information when that other simulator reaches to the synchronization time, wherein the one simulator is so constructed that it obtains the operation data of the other simulator within the common data area, after making a confirmation of the synchronization completion information through accessing to the common data area 90.

In the present embodiment, each the simulator operates, independently, and transmits data through the platform 4, being cooperation or linkage means having the common data area therein, and at the same time, the data in relation to the synchronization process is also transmitted through the platform 4, in the similar manner. Namely, since the platform 4 has the time management means for conducting management on the simulation time between the other simulators when the synchronization request is made from the one simulator, therefore the simulation can be made to perform the synchronization process depending on a necessity thereof, while maintaining the basic simulation format for the integration simulator. Also, through conducting the management on the simulation time between the simulators in relation therewith, only when a request is made from each of the simulators, it is possible to bring the respective simulators in the synchronism with, while maintaining the execution efficiencies and the functions of them.

<Interruption Simulation 21>

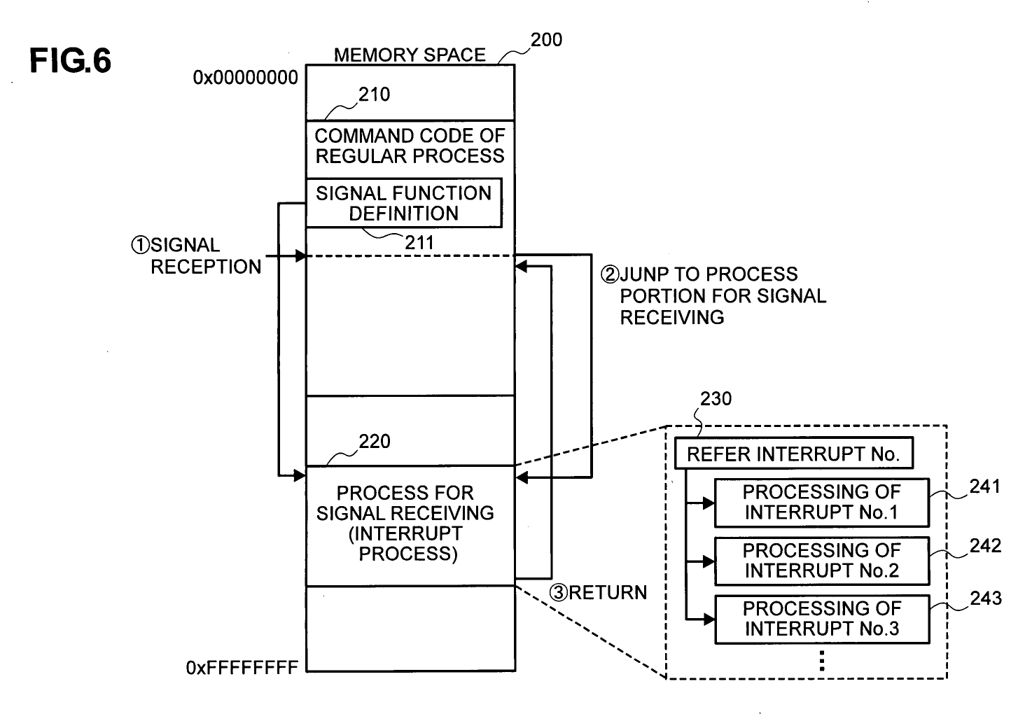

Herein, explanation will be made about an interruption simulation means for making the simulation on the interruption process of the embedded software 8. FIG. 6 is a view for explaining the situation where the interruption simulation is made with using a memory map of the computer. The module 210 of the simulators, such as, the software simulator 1, the electrical-system simulator 2 and the mechanical-system simulator 3, etc., for example, is disposed at an appropriate position on a memory 200, with an aid of the operating system. Within the module, definition is made on a function name to be processed when receiving a signal (211). A portion, which is to be executed actually, is disposed at a position separate from, on the memory, as a sub-module (220). In the present embodiment, definitions are made within this sub-module, about almost all of the settings and the processing steps in relation to the interruption processes. Herein, definitions are made corresponding to the respective interruption numbers, such as, an interruption number referencing process 230, a process 241 of interruption number 1, a process 242 of interruption number 2, and a process 243 of interruption number 3, for example. What is not included herein is only the information about on which interruption number the interruption is made when the electrical-system simulator 2 generates the interruption to the software simulator 1. This is because the interruption number is changed depending on the condition of the mechanical-system simulator 3 and/or the sensor simulator 5, and it can be determined on a side of making the interruption.

The modulator 210 moves the process to a position defined by a signal function definition when receiving a signal during the time of execution thereof. This signal is that which is used within the operating system of the computer; for example, when the electrical-system simulator 2 makes an interruption to the software simulator 1 upon basis of the active flag of the sensor simulator 5, the electrical-system simulator 2 generates a module 210, while attaching an interruption number to the signal. The module 210 makes a search on the interruption number (230) after moving the signal to the position, which is defined by the signal function definition. Next, after conducting the processes 241, 242 and 243, etc., depending on the numbers thereof, it turns back to the original position; i.e., the position where it receives the signal, thereby to continue the processes thereafter.

This interruption process operation is almost similar to the steps of the interruption process within an actual embedded system. Only an aspect differing from that is in that, the position to move differs depending on the interruption number, in the interruption process within the actual embedded system. In the present embodiment, the process at the destination is executed with an aid of the software, so that the simulation on the interruption can be made through the similar operation as in the actual embedded system, with using the signal only for obtaining timing to generate an interruption.

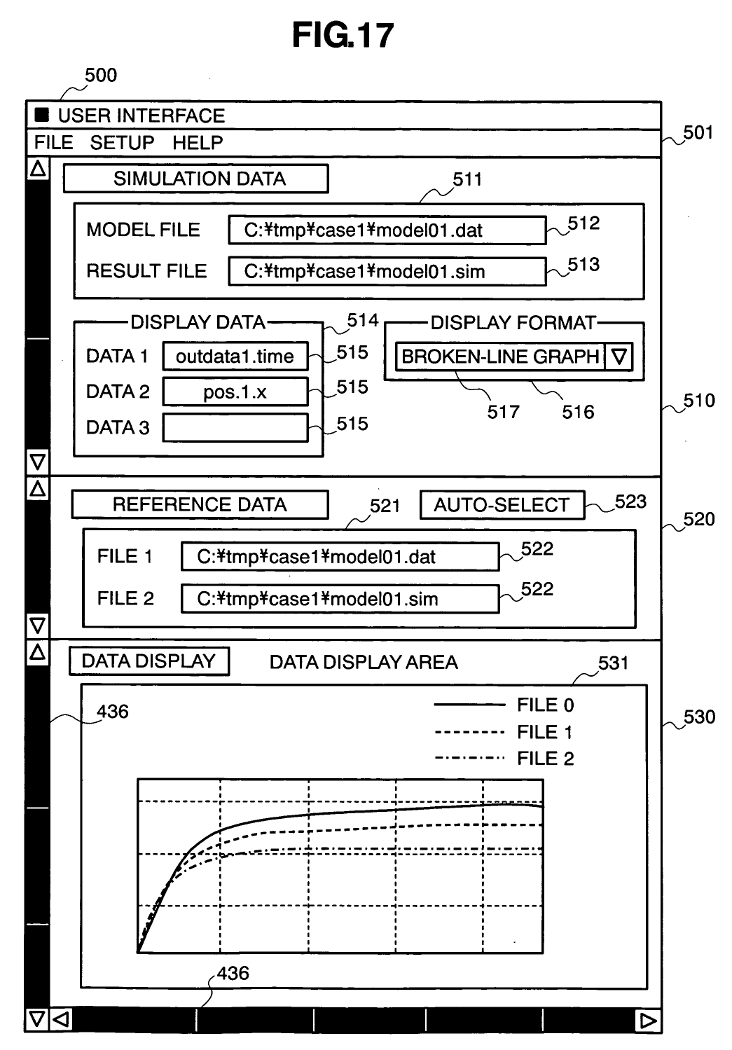

FIG. 17 shows an example of data, which is set up when conducting the interruption simulation. Within an interruption simulation setup data 250 shown in the figure, there are prepared an interruption number 251, a priority level 252, an interruption ask 253, a using signal 254 and an interruption process function 255, in the form of a set with respect to each of the interruption numbers. Also, there are prepared a mask setup method 256 and a mask level 257. The priority level 252 is prepared for defining a degree of priority for the interruption having the each interruption number. The interruption mask 253 is prepared for easy determination on whether the interruption process will be executed or not, when receiving the interruption; i.e., if it is masked, the interruption process will not be executed responding to the interruption received. The using signal 254 is for defining the signal to be used when conducting the interruption simulation. Depending on the kinds of the operating systems, if being able to use the signal within an application, a user can use two (2) signals, i.e., “SIGNAL 1” and “SIGNAL 2”, as the user definitions. The interruption process function 255 is a function name, with which the interruption process is defined for each of the interruption numbers. The mask setup method 256 is for determining a method for setting up the interruption mask, for example, being determined according to a sequential order of the interruption numbers, a sequential order of the priority levels. If the priority order is setup, then on whether it is masked or not is setup with the comparison between a value set in the mask level 257 and a priority of each of the interruptions, and one lower than that mask level 257 in the priority thereof is setup with the mask. It is also similar to that when the mask setup method 256 is in the sequential order of the interruption numbers.

In the present embodiment, since the simulation 21 on the interruption to the software is provided in the software simulator 1, so that the simulation is made onto the interruption with using a signal mechanism of the operating system when the interruption is requested from the simulators in plural numbers thereof, then the simulation can be made upon the interruption in the similar operation to that of the actual software. Namely, in case where the steps of simulations are made up in loop-like in the structure thereof, it is possible to install a process for checking the presence of the interruption into the loop. If installing such the process to check up the presence of the interruption, periodically, into the simulator for the software, in this manner, it is possible to prevent the actual software from differing in the operation thereof.

<User Interface 12>

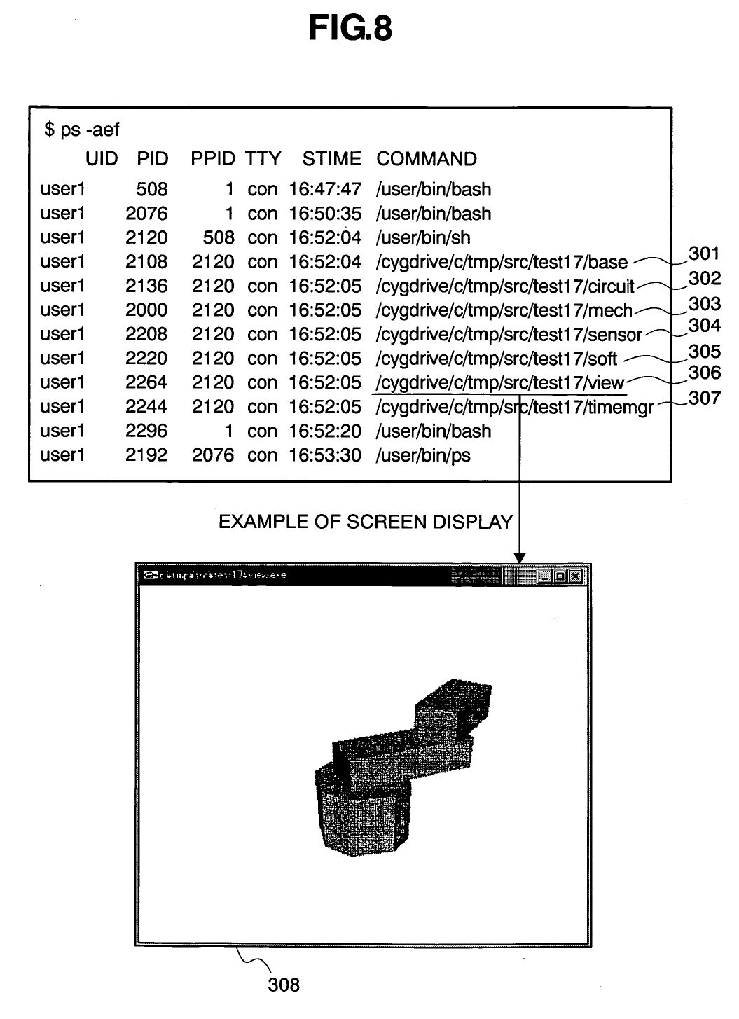

Explanation will be given about display function of the user interface 12, hereinafter. FIG. 8 shows an example of the condition when the simulation is executed. When letting the computer to display the executing process thereof, then the process at that time-point is shown thereon, but only a portion thereof is shown in FIG. 8. A process (in an example shown in FIG. 8, a program name: “base”) 301 for making management on the common data area 90, a process 302 (“circuit” in the same) of the electrical-system simulator 2, and a process 303 (“mech” in the same) of the mechanical-system simulator 3, a process 304 (“sensor” in the same) of the sensor simulator 5, a process 305 (“soft” in the same) of the software simulator 1, a process 306 for use display (“view” in the same), a process 307 for use of management of times (“timemgr” in the same) are indicative of that they are operating, independently, as the respective processes. Though the processing contents in each of the simulators are mainly calculations, however the process for display shows a situation or condition of the simulation on a viewer 60, graphically, so as to show the way how the mechanical system operates to the user. In this instance, that operating condition within a graphic display window 308 for exclusive use thereof, presenting the configuration of the mechanical system with using the CAD data therein. For the user, it is possible to confirm on whether it makes an operation or not, as it is intended, with viewing that display.

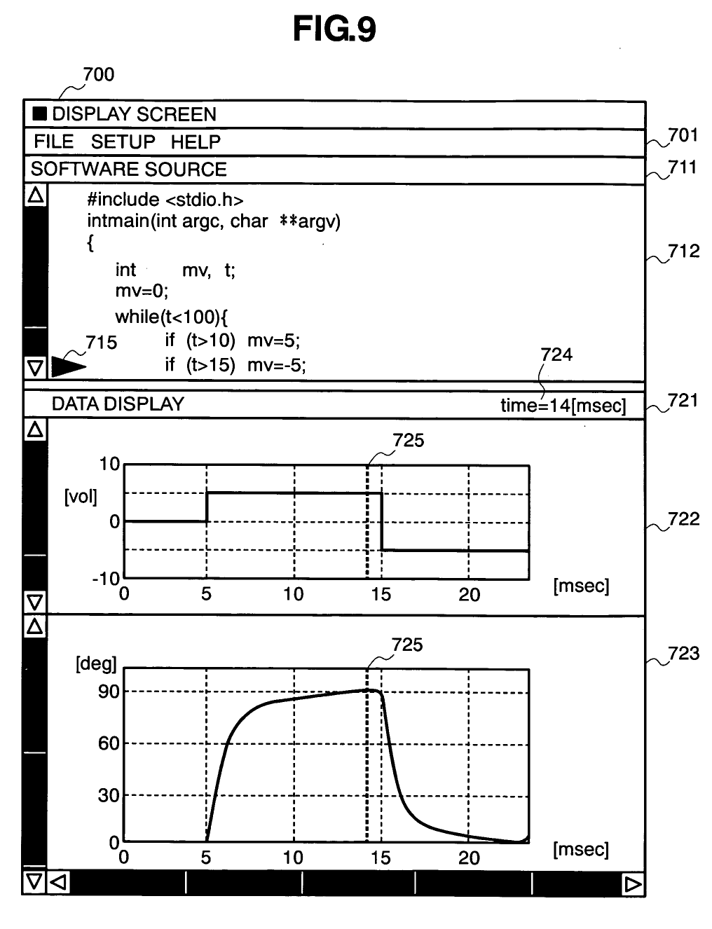

Explanation will be given on an example of displaying the executing conditions the respective simulators, on an integration screen, in FIG. 9. The integration screen 700 has a menu bar 701 for making a selection on an operation menu, a software display title 711 for displaying the software thereon, a source code display area or region 712 for displaying the contents of a source code of the software, electrical-system data display area 722 and mechanical-system data display area 723, for showing the data of the respective simulators for the electrical system and the mechanical system, respectively, and a data display area time 721 for use of data area. Within the source code display area or region 712 is shown the source code of the software, and a portion under execution is indicated with a current line pointer 715. As a method for indicating the portion under execution, a color for displaying the letters or characters of the source code is altered, or is reversed on the display. Thus, it should not be restricted to the pointer display method, as far as distinction can be made from the other portions. The data displayed within the electrical-system data display area 722 and the data displayed within the mechanical-system data display area 723 are made equal to each other on the time scale thereof, and are also controlled in a manner of display, so that the times coincide at the same positions. With this, it is possible to grasp the executing condition of the electrical-system simulator 2 and the executing condition of the mechanical-system simulator 3, while comparing them to each other.

What corresponds to the execution time of a line, which the current line pointer 715 indicates within an inside of a source code display area 712, is displayed by a time indicator 725 within the electrical-system data display area 722 and the mechanical-system data display area 723, while displaying the time thereof in the numerical values thereof. In FIG. 9, the time data 724 is shown in a part of the data display area title. The current line pointer 715 and the time indicator 725 move the position thereof, at any time, in conformity with progress of the integrated simulation. In conformity with this, also the contents are changed, which are displayed in the time data 724. In this manner, the source code, the electrical-system simulator and the mechanical-system simulator are displayed on the same screen, and on the same scale thereof, which are executed by the software simulator.

According to the present embodiment, when the user wishes to make a confirmation upon the condition when executing the integrated simulation, in particular, the condition of the execution timings among the simulators, etc., she/he can grasp that condition, easily, with using the integration display screen 700. Also, when she/he wishes to make the confirmation on the executing condition, but restricting to a specific simulator, it is also possible to apply an individual display screen for it, in the similar manner to that of the conventional display of a result about the ordinary simulation.

<Data Operation Interface 80>

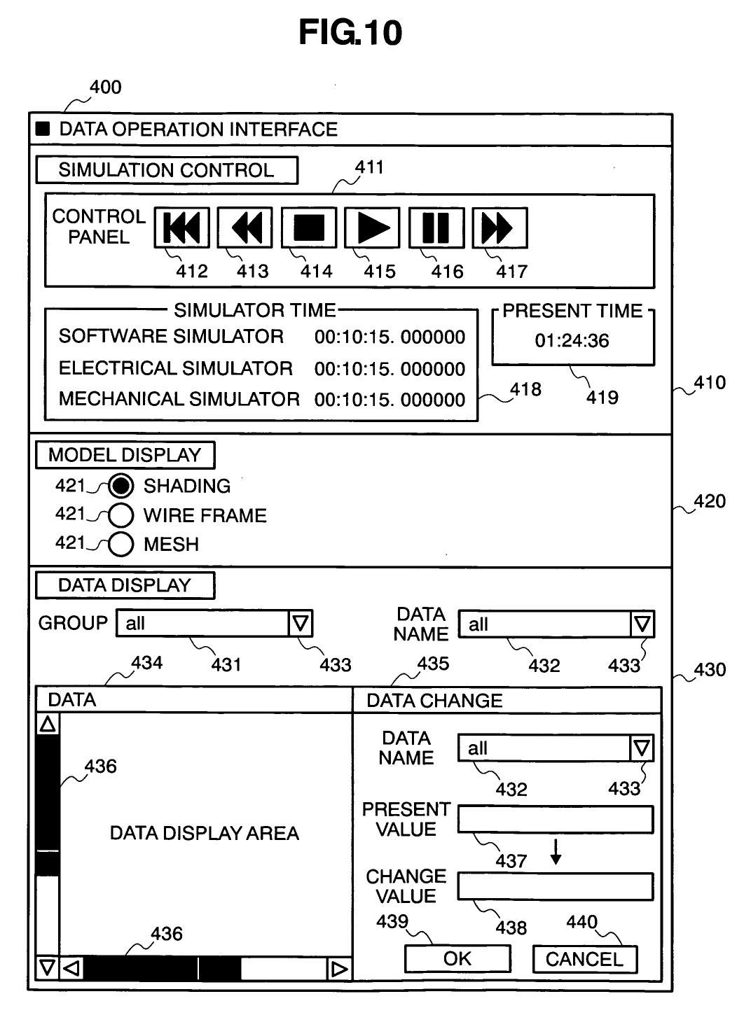

FIG. 10 shows an example of the screen structure of the data operation interface 80. Herein, an operation environment for the user is displayed, with respect to the integrated simulation. A data operation interface screen 400 has a simulation control portion 410, a model display controller portion 420, and a data display/change operation portion 430. The simulation control portion 410 has a controller panel 411 for controlling the execution of simulation, a simulator time display portion 418 for displaying the simulation time for each of the simulators, and a present time display portion 419. On the controller panel 411 are prepared an execution button 415, a pause button 416 for switching over between the pause and re-start, a stop button 414 for stopping, feed forward and feed backward buttons 417 and 413 for feeding forward and/or backward, and a reset button 412 for resetting the simulation time.

The model display controller portion 420 is provided for setting up a display condition for the model to be displayed within the graphic display window 308; for example, there is prepared a selection button for picking up a one from a shading display, a wire frame display and a mesh display.

The data display portion 430 is used for displaying and/or changing the data within the common data area 90. For displaying the data, it is necessary to designate a group data, such as, hardware control data 91, mechanical-system drive data 93, mechanical-system operation data 95, etc., and the data within those, by the data name thereof. Herein, there is shown an example, wherein the data group name and the data name are setup into a data group designation field 431, and a data name designation field 432. Since those are clear when building up the simulators, selection of them may be made from a list display, with using a pull-down menu button 433, for example. The data designated here is displayed in the data display area 434, by the name and the value thereof. In case where the designation is made upon plural selections, such as, “all” or the like, for example, there sometimes occurs cases where the number of characters to be displayed cannot stay within the data display area. In such the cases, reading may be made possible upon the data desired, with using a scroll bar 436. A data change area 435 is provided, so that the user can operate the value of data on the common data area, directly, and there are prepared the data name designation field 432 for designating the data that she/he wishes to change, and the pull-down menu button 433, in the similar manner to the case of the data display. Further, there are provided a present-value display field 437 for displaying the contents of data selected, and a changing-value setup field 438 where a changed value is set up therein. The changed value set up herein comes to be effective in the changing thereof, at the time-point when an “OK” button 440 is pushed down.

With the present embodiment, each of the simulators is operable, independently, and the data are accessible among the simulators through the common data area 90. For this reason, it is possible to add other function(s), easily, and further to operate the data through the image mentioned above. Accordingly, with using the data operation interface 80 of the present embodiment, it is also possible to make up such the conditions, which can be hardly reproduced and/or set up in the actual machine, and/or abnormal conditions, when executing the simulation; therefore, it is also possible to make verification on such the cases, if the software can deal with or not, correctly.

An object, upon which the software actually makes control and operation, is hardware being built up with the actual electrical system and mechanical system; therefore, comparing to a result of simulation obtained through simulation models of the electrical system and the mechanical system and also a result of debug and verification with using the actual machine, it is possible to improve the accuracy on the simulation models.

<Automatic Producing Means of Variable Switching Definition File>

Explanation will be made on a means for extracting an access port (i.e., a physical port) for the electrical system and the mechanical system upon basis of the source program of the software 8, and thereby automatically produces a variable switching definition file, which defines an access address of the common data area 90 corresponding to that access port. When transmitting data through the common data area 90, since the source program of the software 8 is described so as to make input/output of the data to a physical port of the actual electrical system, etc., therefore the software simulator 1 must be constructed while changing an address of input/output of the data to an address of the common data area. Herein, explanation will be made assuming that the embedded software 8 is described in the “C” language. With the program described in the “C” language, the input/output is made in the form similar to the access to a file on a disk, to external devices, such as, a communication port, a printer port, etc. Thus, the device is opened, once, and then an identifier is obtained for making an access thereto. Although differing in the kind thereof depending upon the object, but normally, those are used therein; i.e. , being so-called a file handler, a file pointer and a file descriptor, for example. Into a function and a system call for use of reading and writing are given the identifier and the data by means of argument, thereby making input/output of data. At a time-point when completing the process, the device once opened is closed. Although access can be made to the variable assigned on the memory, by describing the name of variably directly, however the process mentioned above is necessary when accessing to the external devices.

In the present embodiment, since search is made on the above-mentioned necessary process to the external devices, therefore the position thereof accessing to the external device is found out, and then that process is replaced by an address to the data assigned onto the common data area, thereby changing the program of the embedded software into that for use in the simulator. For searching out an actual I/O (261) for accessing to the external devices actually, data 260 is prepared, to be uses as a key for search. For example, there are prepared, open( ), fopen( ), read( ), write( ), fprintf( ), close( ), and fclose( ), as the functions for use in input/output, and as the device names, there are prepared, /dev/com1, /dev/1pt1, /dev/sdal, etc. Depending on the processing system, there are used functions, such as, CreateFile( ) , CreatDC( ), etc., and as the file names, there are used COM1, LPT1, etc. Other than that, in case of equipment of the format to be connected to a PCI slot, an API (Application Programming Interface) for excusive use thereof is prepared, and/or depending on cases, those function names are still usable. With using those function name and device name, and further including a string or line of characters for accessing the external device therein, as a key, search is made on the source program. In the “C” language, since it is possible to define an include file, and/or a device name on option when compiling, etc., then the search can be made, targeting up to the program, the include file, a command file for use in compiling.

When an access portion for the external device is found through the searching, the access variable is kept onto the common data area, and correspondence is made to the identifier. This correspondence is produced in other file as a common data area access interface (I/F) 262, to be added to the source program of the circuit simulator or the mechanical-system simulator. At the same time, with accessing to the common data area, modification or revision is made on an open/close portion and an access portion of the device, which are unnecessary for the original program. With this, it is also possible for the respective simulators 2 and 3 of the electrical system and of the mechanical system to refer the common data area 90, and thereby producing a module enabling the mutual data transmission.

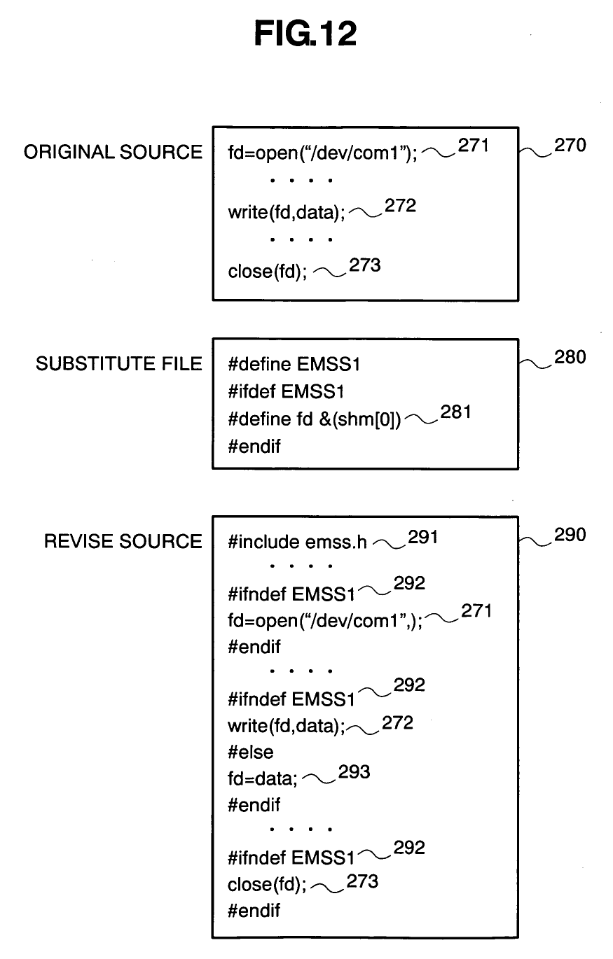

Explanation will be made on an example of a method for modifying the correspondence and the source program, by referring to FIG. 12. It is assumed that, within the original program, there are described an open 271 of a device, an output 272 of data, and a close 273 of the device. The open sentence 271 of the device can be found out, and it can be seen that the file descriptor is “fd”. If making the search by this “fd”, the portion 272 outputting data can be found. Next, the data to be used in the place of “fd” is kept on the common data area, and that replacement is defined therein (281). This is outputted to the file 280. Definition is made (291) for the original source program to read in the above-mentioned file 280 for use of replacement, and a line 292 is added, for instructing a preprocessor not to execute the open sentence 271. With the line 272 outputting the data, an arrangement is made not to execute this (292), but in the place thereof, there is inserted a line 293 in the format of accessing to the common data area 90. Herein, although the string of characters or the character line, i.e., “fd”, being same to that of the file descriptor is used as the data name of address for the access, this is changed into the data name on the common data area when it is compiled, by means of the file 280 defining the replacement mentioned above therein. With the close sentence 273 of the device, in the similar manner to that of the open sentence 271, the sentence 292 is inserted therein, for the preprocessor not to execute that. With those steps mentioned above, it is possible to replace the accesses to the devices to the access onto the common data area 90.

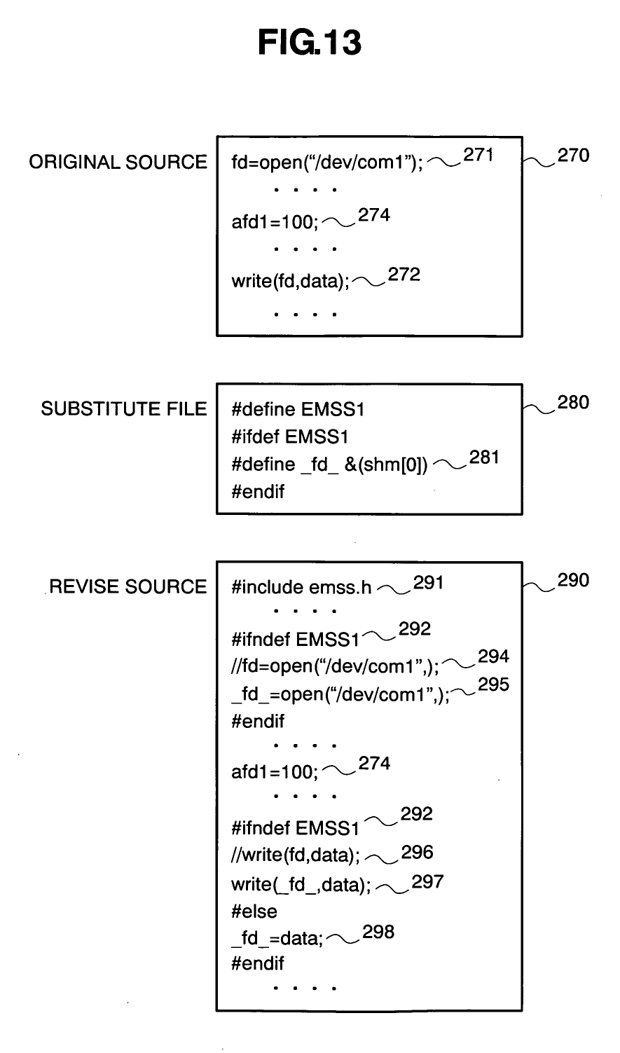

Explanation will be made about the processes in case when the character line, being same to that to be replaced within the source program, is included in other data names and/or the function names, by referring to FIG. 13. When defining the replacement of the character line “fd” within the replacement definition file 280, all of the character lines, i.e., “fd” within the source program be replaced with. However, if other process 274 is described with including this character line therein, there is a possibility that it is also changed; i.e., producing a different process or an erroneous program. For dealing with such the case, first the character line “fd” in a portion relating to the device access is replaced by another, once. In FIG. 13, there is shown an example of adding underscores before and after “fd”, i.e., “_fd_”. Herein, also when the newly defined “_fd_” is used in others, then the underscores are added further before and after thereof, etc. Thus, it is repeated until when no such the duplication appears. With this, the character line, “_fd_” used in the device access comes to be a unique character line, and then the replacement file 280 is produced with using this. Thereafter, the modification or revision similar to that mentioned above is made on the source program. Thus, the other process 274 including the character line “fd” therein is remained, as it is, while with the line relating to the deice, the original thereof is treated to be a comment (294, 296), and the line replaced is added therein (295, 297). However, actually, those added lines would not be executed, due to the preprocessor instruction sentence 292. This addition is made for the purpose of bringing the modification or revision process on the source program to be understandable. Finally, the line 298 of the data access by means of the new title or name “_fd_” is added. However, processing of the close sentence is similar to the case shown in FIG. 12 mentioned above.

Herein, with applying the replacement file 280 produced, adding this to the modules for use of other simulators, and further with using the data name described in the replacement file 280 when referring to the common data area, it is possible to refer to the same data, also for the electrical-system simulator 2 and the mechanical-system simulator 3. As was mentioned above, with analyzing the source program of the embedded software 8 and searching the access position to the physical device, it is possible to execute the program change process for changing the access to the physical device to the access to the common data area, automatically, and thereby enabling to produce the source program for use in the software simulators, automatically. In general, the work, i.e., changing the referring address of the source program, is made manually, with using a program editor, for example; therefore, it is a large-scaled work depending on the scale of program. However. According to the present embodiment, such the work of producing the source program for use in the software simulators can be made, easily.

<Hypothetic Model Simulator>

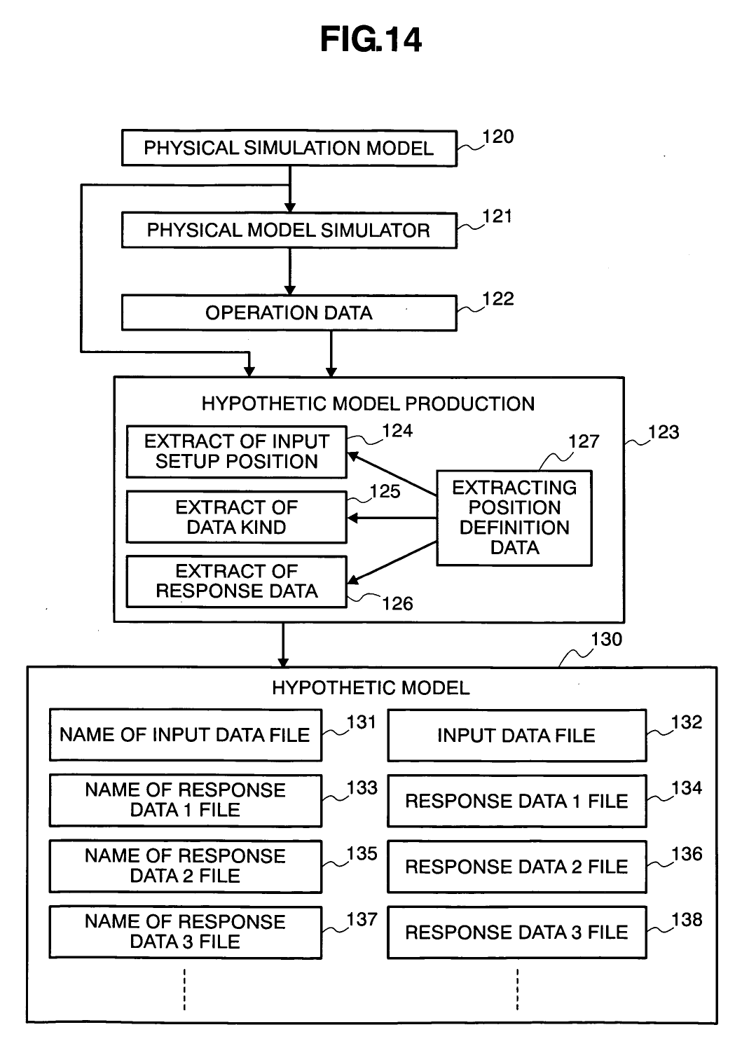

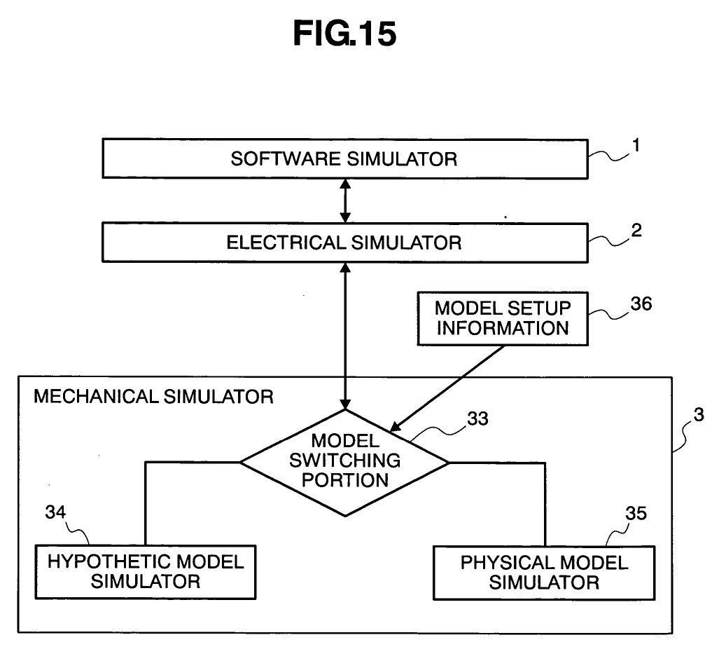

Explanation will be made on a case where the mechanical-system simulator 3 is built up with using a hypothetic model, by referring to FIGS. 14 and 15. In case when making a simulation on the mechanical system, being the hardware, since the operations of the mechanical system is simulated with an aid of the software, therefore, in general, the response time comes to be longer than that of the operation within the mechanical system. For example, when simulating the operation within the mechanical system, the equation of motion is produced from the structures and the characteristics of the mechanical system, and the operation of the mechanical system is calculated out through dissolving that equation of motion. Thus, it takes a long time for calculating out the equation of motion, accurately, and therefore the response time comes to be long. Also, when analyzing the operation by taking the deformation of the mechanical system into the consideration, since it is a combination with an analytic calculation through the finite-element method, therefore the calculation time comes to be longer.

By the way, if the target of the integrated simulation system is to make of developing, debugging and verification of the software, as a first object, then it is necessary to make the time, as short as possible, being necessary for the simulation by the mechanical-system simulator and the electrical-system simulator. For achieving such the object, demands are made on a method of enabling simulation on the operation of mechanical system at high speed, in the place of the general mechanical-system simulator, which applies the general physical model therein, thereby to simulate the operation of mechanical system by means of the software.

In the present embodiment, a hypothetic model of the mechanical system is built up, so as to make a response at high speed. Herein, explanation will be made on a means for producing the hypothetic model with using the result of simulation on the physical model will be explained, as an example of that hypothetic model, by referring to FIG. 14. First, the physical simulation model 120 is produced, and the operation data 122 is obtained through conducting the operation simulation by means of a physical model simulator 121, such as, mechanism analyzing software if it is the mechanical system. Normally, those processes will be done during the detailed designing of the hardware. Accordingly, it is not that which is generated newly for the purpose of producing the hypothetic model, according to the present embodiment.

A hypothetic model producing means 123 comprises at least an input setup portion extracting process 124, a data kind extracting process 125, and a response data extracting process 126. And, it reads the physical simulation model 120 and the operation data 122 therein, so that it extracts the input setup data to the hardware and the kind of data corresponding to the operation portion from the physical simulation model 120. It also converts the input setup data to the hardware into the format for use of the hypothetic model, thereby producing an input data file 132. Also, upon basis of the kind of data corresponding to the operation portion extracted, it extracts response data of data kind from the operation data 122, and thereby producing response data files 134, 136, 138 . . . for each of the data. Those response data files and also the file names 131, 133, 135, 137 . . . thereof are set up to be a hypothetic model 130, collectively.

Since the input setup portion, the data kind, the response data are different in the format to be described depending on the kind of the analyzing software, therefore definition is made in advance, i.e., from where that data is extracted, depending on the analyzing software to be applied. It may be described within the respective extracting means, for example, or may be defined as an extracting position definition data 127, separate from the extracting means. With this, it is possible to product the hypothetic model from the data of physical model simulation.

The hypothetic model is an assembly of the response data, each of which is simulated in advance, responding to an operation instruction from the software simulator 1, through the simulation of the physical model. And, by obtaining the operation result responding to the operation instruction from the software simulator 1, upon basis of the response data, thereby to be stored onto the common data area 90, the simulation time can be shortened, greatly. With this, since an improvement can be made on the response speed of the mechanical-system simulator, therefore the integrated simulation can be improved on the execution efficiency thereof.

An example is shown in FIG. 15, installing the hypothetic model simulator, which is built up in such manner, and the physical model simulator into the mechanical-system simulator 3, thereby conducting the simulation while switching over them depending upon the target of the simulation. Thus, switchover is made between the physical model and the hypothetic model, depending on the object of the simulation or the accuracy required. As an example of the hypothetic model, there is one, which is produced by the hypothetic model producing means, as was explained in FIG. 14.

In FIG. 15, the software simulator 1 outputs the data for operating the mechanical system to the electrical-system simulator 2, and the electrical-system simulator 2 converts it into the data for operating the mechanical system, thereby being outputted to the mechanical-system simulator 3. Within the mechanical-system simulator 3 are installed the model switching portion 33, the physical model simulator 34 and the hypothetic model simulator 35. Upon an instruction from the model setup information, the model switchover portion 33 calls up the physical model simulator 34 when the response data in accuracy is necessary, or the hypothetic model simulator 35 when the response at high speed is necessary.

<Simulation Database 11>

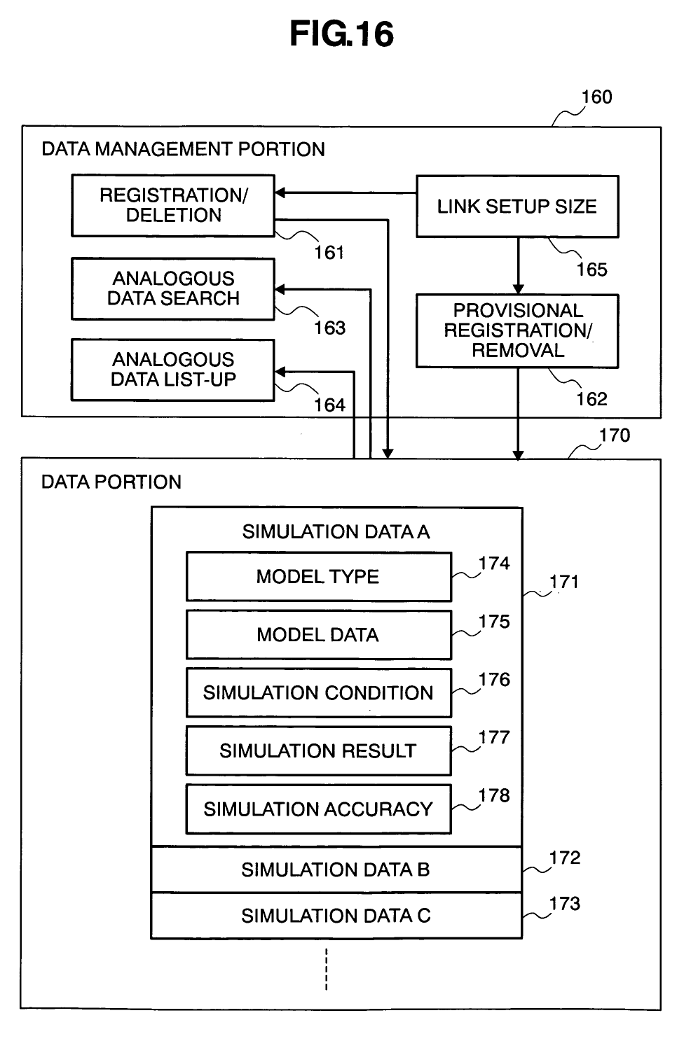

As is shown in FIG. 16, the simulation database 11 is built up with a data management portion 160 and a data portion 170. The data management portion 160 comprises at least a registration/deletion means 161, therein. In the example shown in FIG. 16, so as to perform the simulation with high efficiency, there are provided an analogous data searching means 163, an analogous data list-up means 164, and further a provisional registration/cancellation means 162 for automatically registering the data in relation to a new simulation, temporally, therein.

The provisional registration/cancellation means 162 conducts the provisional registration, automatically, when executing the simulation. The user can remove the provisional registration data from the database, by designating the cancellation thereof, when she/he determines that the provisional registration data is not necessary. However, various kinds of files, which are used in the simulation, are remained, as general data files.

The registration/deletion means 161 really registers the data, which is under the provisional registration, or delete the data really registered from the database. Normally, when it is registered really and/or provisionally, a copy of the file is produced within the data portion 170. However, regarding the file having a size larger than the size that is set within a link setup size 165, registration is made on only link information thereof. This protects the storage capacity thereof from falling into the situation of being suppressed by the files, each having a large volume, as well as, saving the time for copy processing. If the link setup size 165 is non-positive value, then reservation is made into the data portion, for all of the files, in the form of a copy.

The analogous data searching means 163 makes a comparison between the contents of the file, in which the data of models and the simulation conditions are defined, and the data already effected, which are stored within the database, when newly executing the simulation, then if there is an analogous simulation data therein, it pucks up that. A degree of analogy is determined through the comparison upon the file contents of the model data and/or the simulation condition, i.e., the data itself, and is numerically evaluated, with a line number, a data label, values, etc. A degree of coincidence is evaluated by a numerical value, for example, it is “0” when data on the same line number are completely coincident with, between two (2) pieces of files, or “1” when the data differs from each other in one (1) position thereof, and thereafter calculation is made on the summation thereof.

The analogous data list-up means 164 aligns the degrees of analogy calculated out by the analogous data searching means 163, in an order according to size, and displays a list thereof to the user. At this time-point, the user can makes an interruption, immediately, if the simulation presently executed is same to that which was also executed in the past. Or, it can be used, practically, for effective execution of simulations and evaluation of the results, etc., through making the comparison to the past data, or the like.

The data portion 170 collects the data and the files relating to the simulations, into a one (1), thereby to be stored in such manner, i.e., simulation data A 171, the same B 172, the same C 173 . . . , for example. In each of the simulation data, there are included model type 174, model data 175, simulation condition 176, and simulation result 177, at least. In relation to one (1) piece of the model, if there is a result of execution of high-accuracy simulation, such as, the simulation result of applying the physical model simulator therein, etc., for example, it is possible to add the difference from that, therein, as being simulation accuracy 178. Since the simulation accuracy 178 mainly depends on a method of modeling, therefore by referring to that data, it is possible to grasp the simulation time and the accuracy thereof, roughly, about the different target of simulation, before executing that simulation. Or, in case when an expect can be made that the accuracy is not enough or that the simulation time is too long, etc., it is possible to change the method for modeling, so as to execute the simulation thereon.

<Example of Display of User Interface 12>

Explanation will be made on an example of displaying the user interface on the display apparatus, with using the data of the simulation database 11, by referring to FIG. 17. The user interface 12 is able to display the data on the screen, in relation to the modeling and the result of the simulation. Within the display screen of the user interface 12 are included a main display data setup portion 510, a data display portion 530, and menu bar 501, at least.

In the example of display shown in FIG. 17, for enabling to make display/comparison of simulation results in plural numbers thereof, there is provided a reference data setup portion 520, for example. In the main display data setup portion 510, there are provided a file name designation portion 511, a display data setup portion 514, and a display format setup portion 516, at least. Within the file name designation portion 511, a file name of the simulation model is designated into a model file setup field 512, a file name of the simulation result into a result file setup field 513, respectively. Within the display data setup portion 514, a data name of the data to be displayed is set into a data name setup field 515, from a large number of data kinds displayable. Within the display format setup portion 516, selection is made on which kind of format the data should be displayed, to be set into a display format selection portion 517. As the display format, there is a graph format, first of all, such as, a bar graph, a broken line graph, a circular graph, for example, and are also various kinds of formats for display, which can be applied therein, such as, an animation display of displaying the operating conditions of the hardware, continuously, in accordance with the passage of time, a model configuration, and mapping on the model configuration, etc.

In the reference data setup portion 520, a file name to be referred to is set into a reference file setup field 522 within a reference file name designation portion 521. When an automatic selection button 523 is pushed down, selection is made, automatically, upon the files at higher degree of analogy of the analogous data, which are listed up by the analogous data search means mentioned above.

Within the data display portion 530, there is provided a data display area or region 531, wherein the data is displayed, which is set up in the main display data setup portion 510 and the reference data setup portion 520.

Next, detailed example of the menu bar 501 will be shown in FIG. 17. The same figure shows the menu structure when selecting “file” on the menu bar 501. Selection of “new window” makes a similar screen open, separately. Selection of “open” or “close” makes designation on the file to be set into the file name setup field, which is selected at that time-point. Selection of “overwrite reservation” brings the data under processing to be written into the same file, in the overwriting mode. Selection of “save in another name” makes the data output into a file in another format. In this instance, under the sub-menu thereof, the followings can be conducted; i.e., designation of file name, selection of data to be saved or reserved, selection of the save format. As the save format, there are the following; i.e., a text format, a table format, a document/drawing format, an image format, etc., being the most general ones. The data reserved in another format by means of this function can be also processed/edited by other tool(s), which can deal with that format, and therefore, it is possible to conduct an estimation on the results and/or production of documents or the like, with preferable efficiency. Selection of “print” designates the data to be printed and a printer, and thereby printing out that data. Selection of “end” results into closure of the user interface screen.

FIG. 19 shows an example of the menu structure, in particular, in case when “setup” is selected. Selection of “window mode” makes setup on a mode of opening the window; i.e., in particular, in case when opening a new area or region within the window of the user interface screen, the screen is displayed in “new window” form, if “multi” is selected, while it is opened as another window, if “single” is selected, for example. Under “main data selection”, setup is made on the kinds of selectable data, such as, the model fines, the files of simulation conditions, the files of the simulation results, etc. “maximum data number” determines the maximum number of the kinds of data, which can be treated within the same area. Selection of “maximum reference file number” determines the maximum number of the files to be referred to.

In this manner, the user interface 12 according to the present embodiment is constructed to have the display mode selecting means therein, so as to display the simulation condition(s) of the respective simulator(s), alone or aligning them in a group, on the display device, graphically. With this, for the user, it is possible to make a confirmation upon the simulation conditions of the respective simulators, for the software, the electrical system, and the mechanical system respective, appropriately. Accordingly, in case where a problem occurs in the operations and so on, of the respective simulators, such as, for the software, the electrical system, and the mechanical system respective, then for the user, it is possible to study the reasons and so on of that problem, easily.

<Simulator and Simulation on Actual Machine>

The present embodiment may be so constructed that it can deal with, not only limited to the simulation by means of the simulator limited, but also an integrated simulation upon an actual machine. In such case, within the common data area 90, there is provided a switching function for switching over, so that each can make an access to the actual machine alone, or in combination with the simulator of itself, respectively. And, the user interface 12 makes management upon an object and processing time of the simulator and also the simulation accuracy, in the combination of the simulation including the actual machine and the simulation result thereof. As a result thereof, it is possible to provide an appropriate simulation modeling depending on the object, the processing time, and the accuracy, and thereby it is possible to improve the accuracy of the simulation modeling. The user interface 12 may also make the data corresponding thereto, to be displayed on the display device or apparatus in the same expression, about plural number of the simulation results. It is also possible to provided an output means for outputting the simulation models, the simulation conditions and the simulation results, which are stored within the database, in the form of data corresponding to an arbitrary display device or apparatus.

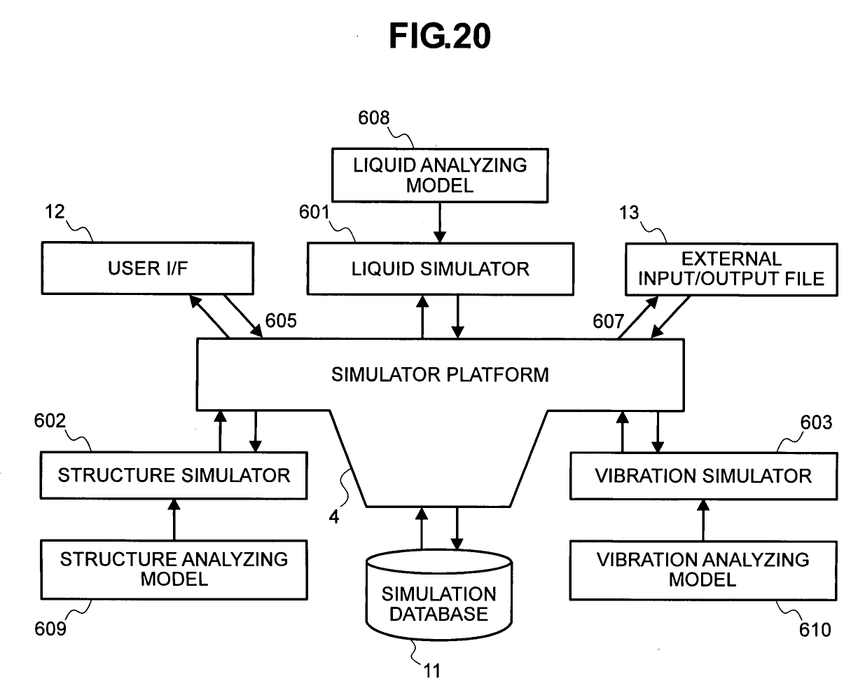

FIG. 20 shows the block diagram of another embodiment, in which the integrated simulation according to the present invention is applied. The present embodiment is applied, in particular, into an integrated simulation of liquid/structure/vibration. A liquid simulator 601 takes a liquid analyzing model as the input data thereof, the structure simulator 602 takes the structure analyzing model 609 as the input data thereof, and the vibration simulator 603 takes a vibration analyzing model 610 as the input data thereof. For the liquid, the structure, and the vibration, since they are different from one another, in the analyzing objects thereof; therefore, there is a necessity of mutually transmitting the data among them, to be boundary condition data, when trying to make simulation on complex phenomenon, while treating those integrally. The simulation platform 4 is the mechanism for conducting the data transmission among the simulators; therefore, it is possible to achieve the integrated simulation on the liquid/structure/vibration, with such the system configuration same to that of the embodiment 1. Also, the user interface 12 and the external input/output file 13 are independent from the other simulators; therefore, it is possible to share them in common, similar manner to the platform 4.

As was fully mentioned in the above, according to each of the embodiments mentioned above, even when applying the simulators for the software, the electrical system and the mechanical system, respectively, it is possible to bring the respective simulators, to operate in corporation with one another, in the simulation on the complex phenomenon, for dealing with the different physical phenomena, such ask the liquid, the structure, and the vibration, for example. And, it is also possible to execute the integrated simulation, effectively, while maintaining the executing efficiency and the function of the simulator, respectively.

The present invention may be embodied in other specific forms without departing from the spirit or essential feature or characteristics thereof. The present embodiment(s) is/are therefore to be considered in all respects as illustrative and not restrictive, the scope of the invention being indicated by the appended claims rather than by the forgoing description and range of equivalency of the claims are therefore to be embraces therein.

FIG. 1

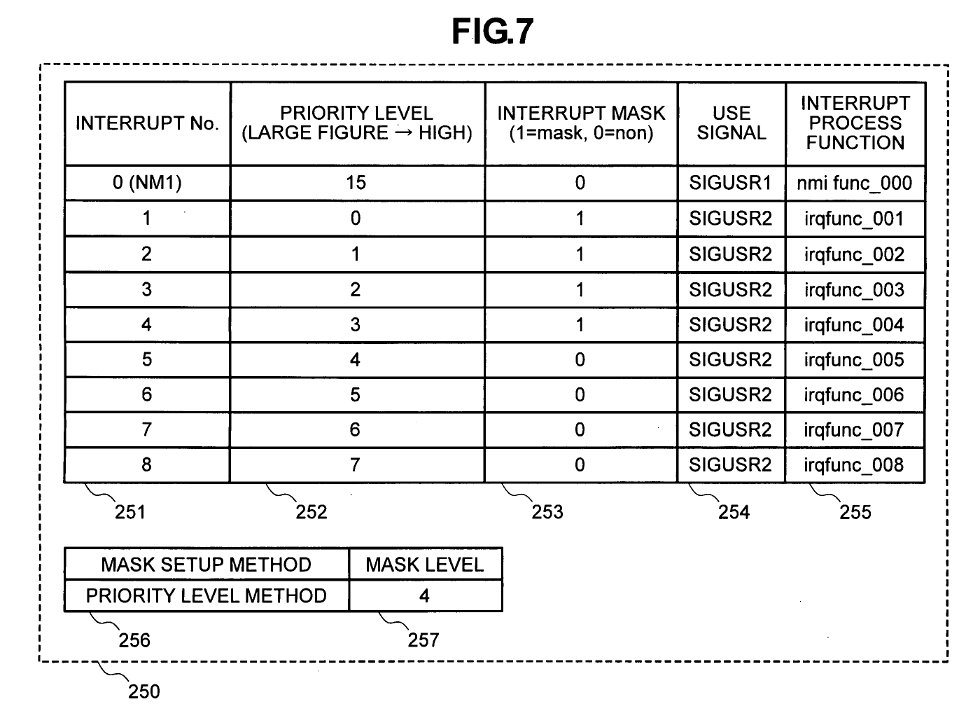

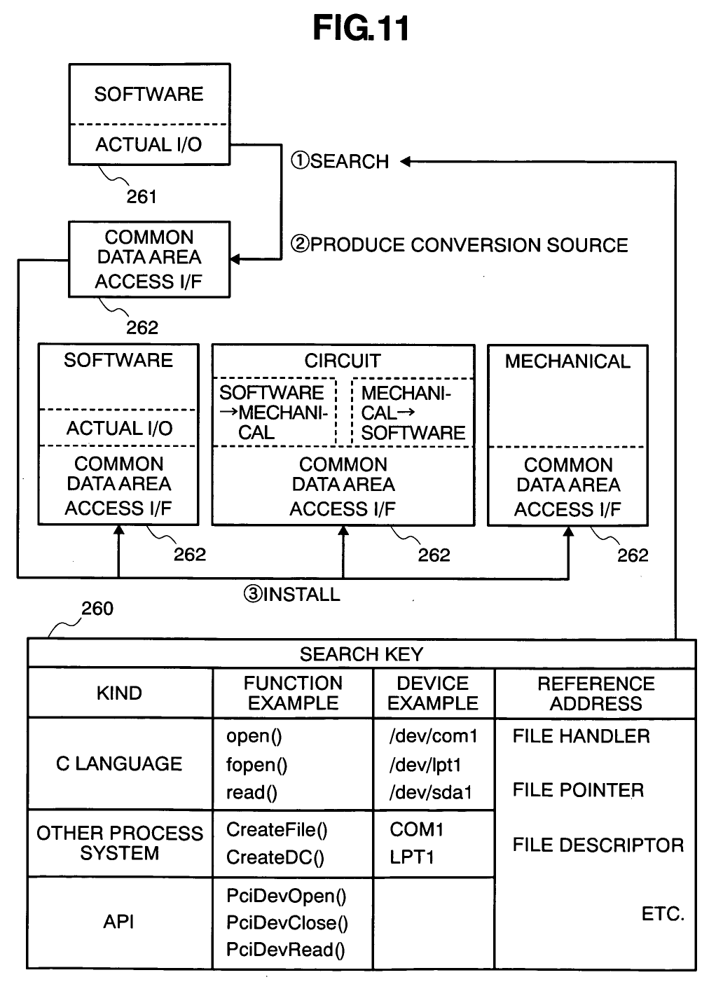

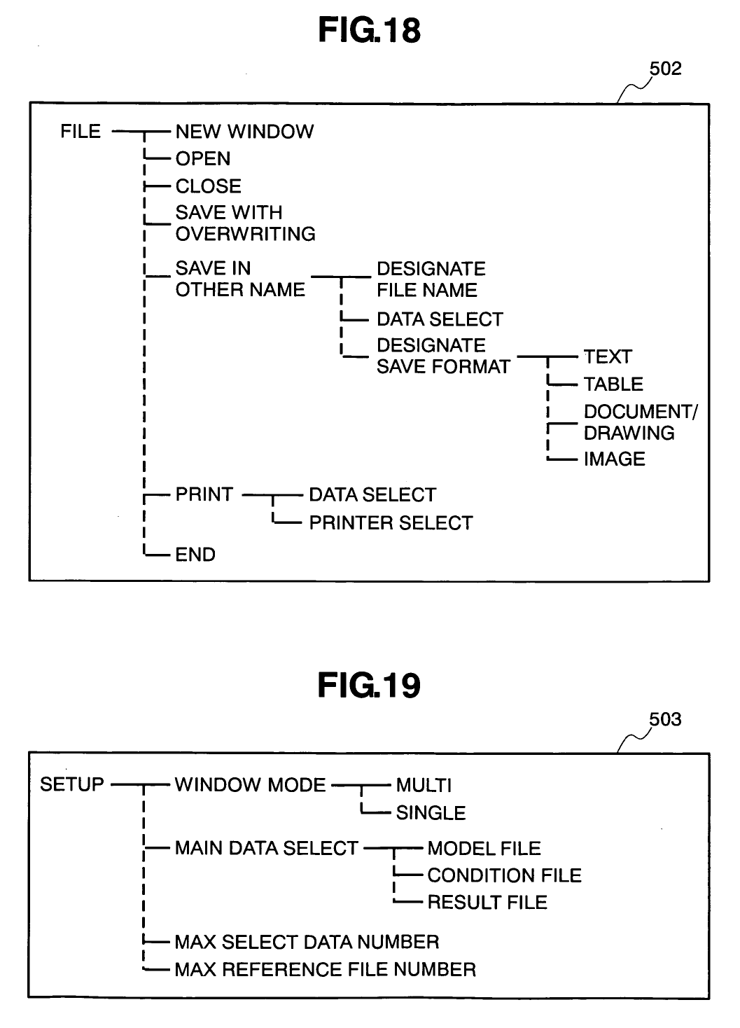

EMBEDDED SOFTWARE
USER I/F
SOFT SIMULATOR
EXTERNAL INPUT/OUTPUT FILE
SIMULATOR PLATFORM
ELECTRICAL SIMULATOR
MECHANICAL SIMULATOR
CIRCUIT DATA
ACTUAL MACHINE CIRCUIT
SIMULATION DATABASE
ACTUAL MACHINE MECHANISM
CAD DATA
   FIG. 2
SOFTWARE
INTERRUPT PROCESS
INTERRUPT SIGNAL
ELECTRICAL
SOFTWARE→MECHANICAL
MECHANICAL→SOFTWARE
SENSOR
MECHANICAL
VIEWER
TIME MANAGEMENT
COMMON DATA AREA
HARDWARE CONTROL DATA
HARDWARE CONDITION DATA
MECHANICAL DRIVE DATA
INTERRUPT SETUP DATA
SENSOR ACTIVE FLAG
MECHANICAL OPERATION DATA
DISPLAY SETUP PARAMETER
TIME DATA
DATA OPERATION I/F
   FIG. 3
START
INITIALIZATION
IS SIMULATION ENDED?
ENDED EXECUTE
READ-IN SETUP DATA FOR INPUT
OPERATION SIMULATION
OUTPUT OF RESULT
END
   FIG. 4
PROCESS
SYNCH REQUEST FLAG
SYNCH COMPLETE FLAG
SYNCH REQUEST PROCESS
PRESENT TIME
SYNCH TIME
SOFTWARE SOFTWARE
ELECTRICAL
MECHANICAL
   FIG. 5
START
INITIALIZATION
IS SIMULATION ENDED?
ENDED EXECUTE
READ-IN SETUP DATA FOR INPUT
OPERATING SIMULATION
OUTPUT OF RESULT
CONFIRM SYNCH REQUEST IS MADE?
CHECK SYNCH COMPLETE?
NOT COMPLETED
COMPLETED
SET SYNCH COMPLETE FLAG
END
   FIG. 6
MEMORY SPACE
COMMAND CODE OF REGULAR PROCESS
SIGNAL RECEPTION
SIGNAL FUNCTION DEFINITION
PROCESS FOR SIGNAL RECEIVING (INTERRUPT PROCESS)
JUMP TO PROCESS PORTION FOR SIGNAL RECEIVING
REFER INTERRUPT No.
PROCESSING OF INTERRUPT No. 1
PROCESSING OF INTERRUPT No. 2
PROCESSING OF INTERRUPT No. 3
RETURN
   FIG. 7
INTERRUPT No.
PRIORITY LEVEL
(LARGE FIGURE→HIGH)
INTERRUPT MASK
USE SIGNAL
INTERRUPT PROCESS FUNCTION
MASK SETUP METHOD
MASK LEVEL
PRIORITY LEVEL METHOD
   FIG. 8
EXAMPLE OF SCREEN DISPLAY
   FIG. 9
DISPLAY SCREEN
FILE SETUP HELP
SOFTWARE SOURCE
DATA DISPLAY
   FIG. 10
DATA OPERATION INTERFACE
SIMULATION CONTROL
CONTROL PANEL
SIMULATOR TIME
SOFTWARE SIMULATOR
ELECTRICAL SIMULATOR
MECHANICAL SIMULATOR
PRESENT TIME
MODEL DISPLAY
SHADING
WIRE FRAME
MESH
DATA DISPLAY
GROUP
DATA NAME
DATA
DATA DISPLAY AREA
DATA CHANGE
DATA NAME
PRESENT VALUE
CHANGE VALUE
   FIG. 11
SOFTWARE
ACTUAL I/O
SEARCH
PRODUCE CONVERSION SOURCE
COMMON DATA AREA
ACCESS I/F
SOFTWARE
ACTUAL I/O
COMMON DATA AREA
ACCESS I/F
CIRCUIT
SOFTWARE→MECHANICAL
MECHANICAL→SOFTWARE
COMMON DATA AREA
ACCESS I/F
MECHANICAL
COMMON DATA AREA
ACCESS I/F
INSTALL
SEARCH KEY
KIND
FUNCTION EXAMPLE
DEVICE EXAMPLE
REFERENCE ADDRESS
C LANGUAGE
OTHER PROCESS SYSTEM
FILE HANDLER
FILE POINTER
FILE DESCRIPTOR ETC.
   FIG. 12
ORIGINAL SOURCE
SUBSTITUTE FILE
REVISE SOURCE
   FIG. 13
ORIGINAL SOURCE
SUBSTITUTE FILE
REVISE SOURCE
   FIG. 14
PHYSICAL SIMULATION MODEL
PHYSICAL MODEL SIMULATOR
OPERATION DATA
HYPOTHETIC MODEL PRODUCTION
EXTRACT OF INPUT SETUP PORTION
EXTRACT OF DATA KIND
EXTRACT OF RESPONSE DATA
EXTRACTING POSITION DEFINITION DATA
NAME OF INPUT DATA FILE
NAME OF RESPONSE DATA 1 FILE
NAME OF RESPONSE DATA 2 FILE
NAME OF RESPONSE DATA 3 FILE
INPUT DATA FILE
RESPONSE DATA 1 FILE
RESPONSE DATA 2 FILE
RESPONSE DATA 3 FILE
   FIG. 15
SOFTWARE SIMULATOR
ELECTRICAL SIMULATOR
MODEL SETUP INFORMATION
MECHANICAL SIMULATOR
MODEL SWITCHING PORTION
PHYSICAL MODEL SIMULATOR
HYPOTHETIC MODEL SIMULATOR
   FIG. 16
DATA MANAGEMENT PORTION
REGISTRATION/DELETION
ANALOGOUS DATA LIST-UP
ANALOGOUS DATA SEARCH
LINK SETUP SIZE
PROVISIONAL REGISTRATION/REMOVAL
DATA PORTION
SIMULATION DATA A
MODEL TYPE
MODEL DATA
SIMULATION CONDITION
SIMULATION RESULT
SIMULATION ACCURACY
SIMULATION DATA B
SIMULATION DATA C
   FIG. 17
USER INTERFACE
FILE SETUP HELP
MODEL FILE
RESULT FILE
DISPLAY DATA
DATA 1 DATA 2 DATA 3
DISPLAY FORMAT
BROKEN-LINE GRAPH
REFERENCE DATA
AUTO-SELECT
FILE 1 FILE 2
DATA DISPLAY DATA DISPLAY AREA
FILE 0 FILE 1 FILE 2
SIMULATION DATA
   FIG. 18
FILE
NEW WINDOW
OPEN
CLOSE
SAVE WITH OVERWRITING
SAVE IN OTHER MANE
DESIGNATE FILE NAME
DATA SELECT
DESIGNATE SAVE FORMAT
TEXT TABLE DOCUMENT/DRAWING
IMAGE
PRINT
DATA SELECT
PRINTER SELECT
END
   FIG. 19
SETUP
WINDOW MODE
MULTI
SINGLE
MAIN DATA SELECT
MODEL FILE
CONDITION FILE
RESULT FILE
MAX SELECT DATA NUMBER
MAX REFERENCE FILE NUMBER
   FIG. 20
LIQUID ANALYZING MODEL
USER I/F
LIQUID SIMULATOR
EXTERNAL INPUT/OUTPUT FILE
SIMULATOR PLATFORM
STRUCTURE SIMULATOR
STRUCTURE ANALYZING MODEL
SIMULATION DATABASE
VIBRATION SIMULATOR
VIBRATION ANALYZING MODEL

What is claimed is:

1. An integrated simulation system, for integrally simulating a simulation target having a plural number of elements therein, comprising:
simulators, each being provided, independently, for each of said elements, for simulating said elements, respectively; and
a corporation means having a common data area for connecting said plural number of simulators accessible thereto, wherein
said corporation means has a time management means for managing simulation time, when a synchronization request is issued from one of said simulators, between the simulator requested to be in synchronism.

2. The integrated simulation system, as described in the claim 1, wherein said plural numbers of simulators are able to transmit data, mutually, through said common data area.

3. The integrated simulation system, as described in the claim 1, wherein each of said simulators takes synchronization on the simulation time, with using said time management means, when a simulation process of itself is a process relating to a simulation of other simulator.

4. The integrated simulation system, as described in the claim 3, within said common data area are provided with an area for storing synchronization time information therein, which can be shared in common with said simulator issuing the synchronization request and the simulator requested to be in synchronism therewith, and an area for storing synchronization completion information therein, which is generated when said simulator requested to be in synchronism there with reaches to a synchronization time, whereby said simulator requesting synchronization obtains operation data of said simulator requested to be in synchronization within said common data area, after confirming the synchronization completion information through accessing to the common data area.

5. The integrated simulation system, as described in the claim 1, further comprising a data operation interface, being connected accessible to said cooperation means, wherein said data operation interface can change the data within said common data area, when any one of said plural numbers of simulators executes simulation.

6. The integrated simulation system, as described in the claim 1, wherein said plural numbers of simulators includes a software simulator for simulating software embedded into equipment, a mechanical-system simulator for simulating a mechanical apparatus, which is driven and controlled by said software, and an electrical-system simulator for simulating an electrical system, which converts data transmitted between said software simulator and said mechanical-system simulator.

7. The integrated simulation system, as described in the claim 6, wherein said cooperation means can transmit the data between said software simulator and said mechanical-system simulator, directly.

8. The integrated simulation system, as described in the claim 6, wherein each of said mechanical-system simulator and said electrical-system simulator has a switching means, for switching over if it individually accesses an actual machine to said common data area, respectively, or if it accesses the simulator of itself in combination with the actual machine.

9. The integrated simulation system, as described in the claim 6, wherein said mechanical-system simulator comprises a hypothetic model simulator therein, and said hypothetic model simulator has a response data, which is simulated in advance, responding to an operation instruction of said software simulator, so as to obtain an operation result responding to the operation instruction of said software simulator, upon said response data, thereby to be stored within said common data area.

10. The integrated simulation system, as described in the claim 6, wherein said software simulator has a means for extracting an access port for accessing to said electrical-system simulator and said mechanical-system simulator, upon basis of source program of said software, and for automatically producing a variable switching definition file for use of referring to the common data area, defining an access address on said common data area corresponding to said access port.

11. The integrated simulation system, as described in the claim 6, further comprising:
a database for reserving and managing the simulation models, constituent elements of said simulation models, the simulation conditions, and the simulation results of said software simulator, said mechanical-system simulator and said electrical-system simulator.

12. The integrated simulation system, as described in the claim 11, further comprising:
a user interface for enabling to search, refer and edit the information of said database, in relation to execution of the simulation.

13. The integrated simulation system, as described in the claim 11, further comprising:
an output means for outputting said simulation models, said simulation conditions, and said simulation results, which are stored within said database, through data in a format corresponding to an arbitrary display apparatus.

14. The integrated simulation system, as described in the claim 12, wherein said user interface compares the simulation model and the simulation condition to contents of those reserved within said database, when the simulation is executed, so as to provide a simulation model and a result thereof, which are same or analogous thereto, before execution of the simulation.

15. The integrated simulation system, as described in the claim 12, wherein said cooperation means has a switching means for switching over if it individually accesses an actual machine to said common data area, respectively, or if it accesses the simulator of itself in combination with the actual machine, and also said user interface makes management on the object, the processing time and the simulation accuracy of the simulation, in combination with those simulations, including the actual machine therein, and simulation results thereof, thereby being able to provide a simulation modeling depending on the object, the processing time and the accuracy thereof.

16. The integrated simulation system, as described in the claim 12, wherein said user interface displays data corresponding thereto, about plural numbers of simulation results, in same expression thereof, on the display apparatus.

17. An integrated simulation system, comprising:
a plural number of independent simulators, each simulating a plural number of elements building up a simulation target;
a cooperation means having a common area, with which said plural number of simulators in an accessible manner; and
a user interface having a display means for displaying simulation conditions of said plural number of simulators, wherein
said user interface has a display mode selecting means for displaying the simulation conditions of said respective simulators, alone or in a group thereof.

18. The integrated simulation system, as described in the claim 17, wherein said plural number of simulators includes a software simulator for simulating software, which is embedded into equipment, a mechanical-system simulator for simulating a mechanical apparatus which is driven and controlled by said software, and an electrical-system simulator for simulating an electric circuit system, which converts data transmitted between said software simulator and said mechanical-system simulator.

19. An integrated simulation system, comprising:
a plural number of independent simulators, each simulating a plural number of elements building up a simulation target;
a cooperation means having a common area, with which said plural number of simulators in an accessible manner; and
an interruption processing means for simulating an interruption with using a signal mechanism of an operating system, when an interruption request is made from said plural number of simulators.
